(19) United States
(12) Patent Application Publication
(10) Pub. No.: US 2013/0212333 A1
(43) Pub. Date: Aug. 15, 2013

(54) INFORMATION PROCESSING APPARATUS, METHOD OF CONTROLLING MEMORY, AND MEMORY CONTROLLING APPARATUS

(71) Applicant: FUJITSU LIMITED, (US)

(72) Inventors: Atsushi MOROSAWA, Kawasaki (JP); Takaharu Ishizuka, Kawasaki (JP); Hiroshi Kawano, Kawasaki (JP); Takeshi Owaki, Kawasaki (JP); Keita Kitago, Kawasaki (JP)

(73) Assignee: FUJITSU LIMITED, Kawasaki-shi (JP)

(21) Appl. No.: 13/839,928

(22) Filed: Mar. 15, 2013

Related U.S. Application Data
(63) Continuation of application No. PCT/JP2010/005756, filed on Sep. 23, 2010.

(51) Int. Cl. G06F 12/08

(52) U.S. Cl. CPC G06F 12/084
USPC 711/130

(57) ABSTRACT

An information processing apparatus provided with a plurality of nodes each including at least one processor, a system controller, and a main memory, includes a status storage unit that stores statuses of a plurality of cache lines and that is capable of reading statuses of a plurality of cache lines by one reading operation, a recording unit that is provided in a system controller in at least one node and that records all or part of the statuses stored in the status storage unit, wherein the system controller records obtained statuses in the recording unit on a condition that all of the statuses of the plurality of cache lines obtained by reading the status storage unit are invalid statuses or shared statuses in different nodes when the system controller has read the status storage unit in response to a request.

### CROSS-REFERENCE TO RELATED APPLICATION

This application is a continuation application of International Application PCT/JP2010/005756 filed on Sep. 23, 2010 and designated the U.S., the entire contents of which are incorporated herein by reference.

### FIELD

The embodiments discussed herein are related to a memory accessing technique.

### BACKGROUND

A large-scale information processing apparatus having a plurality of central processing units (CPUs) employs a configuration in which a plurality of nodes are connected via system controllers. For connections between system controllers, crossbars are used. The performance of this type of information processing apparatuses is greatly influenced by latency in the memory control.

Regarding memory control, a configuration is known in which cache data corresponding to main data stored in a main memory of the node holds identification information related to the main data not stored in cache memories of a plurality of nodes other than the node (For example, Japanese Laid-open Patent Publication No. 2009-223759).

Regarding memory control, a configuration is known in which access request processing time is reduced by reducing the number of times of issuing snoops, which maintain the coherence between cache memories (for example, Japanese Laid-open Patent Publication No. 2008-310414).

Regarding memory control, a configuration is known in which a retention tag is kept for holding a fact that no cache memories controlled by the node store target data other than DATG for managing data in cache memories (for example, Japanese Laid-open Patent Publication No. 2006-202215).

### SUMMARY

According to an aspect of the embodiment, an information processing apparatus provided with a plurality of nodes each including at least one processor, a system controller, and a main memory, includes a status storage unit that stores statuses of a plurality of cache lines and that is capable of reading statuses of a plurality of cache lines by one reading operation, a recording unit that is provided in a system controller in at least one node and that records all or part of the statuses stored in the status storage unit, wherein the system controller records obtained statuses in the recording unit on a condition that all of the statuses of the plurality of cache lines obtained by reading the status storage unit are invalid statuses or shared statuses indifferent nodes when the system controller has read the status storage unit in response to a request.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF THE DRAWINGS

FIG. 1 illustrates an example of an information processing apparatus according to a first embodiment;

FIG. 2 illustrates a flowchart of an example of a sequence of information processing;

FIG. 3 illustrates an example of an information processing apparatus according to a second embodiment;

FIG. 4 illustrates configurations of a main memory, a DIR, and a recording unit;

FIG. 5 illustrates usage of data read from the DIR;

FIG. 6 illustrates recording to the DIR$ from reading the DIR;

FIG. 7 illustrates recording of information in the recording unit after reading information from the DIR;

FIG. 8 illustrates an example of using data read from the recording unit;

FIG. 9 illustrates a comparison table between the DIR, the DIR$, and the recording unit;

FIG. 10 illustrates a flowchart of an example of an accessing process;

FIG. 11 illustrates an example of an information processing apparatus;

FIG. 12 illustrates an example of a DIR format;

FIG. 13 illustrates operation example 1 of the information processing apparatus;

FIG. 14 illustrates operation example 2 of the information processing apparatus;

FIG. 15 illustrates operation example 3 of the recording unit;

FIG. 16 illustrates a format and a use example of the recording unit as operation example 4;

FIG. 17 illustrates operation example 5 of the information processing apparatus;

FIG. 18 illustrates operation example 6 of the information processing apparatus;

FIG. 19 illustrates operation example 7 of the information processing apparatus;

FIG. 20 illustrates operation example 8 of the information processing apparatus;

FIG. 21 illustrates operation example 9 of the information processing apparatus;

FIG. 22 illustrates operation example 10 of the information processing apparatus;

FIG. 23 illustrates operation example 11 of the information processing apparatus;

FIG. 24 illustrates operation example 12 of the information processing apparatus;

FIG. 25 illustrates operation example 13 of the information processing apparatus;

FIG. 26 illustrates operation example 14 of the information processing apparatus;

FIG. 27 illustrates operation example 15 of the information processing apparatus;

FIG. 28 illustrates a flowchart of an accessing process according to an alternative embodiment;

FIG. 29 illustrates comparison example 1; and

FIG. 30 illustrates comparison example 2.

### DESCRIPTION OF EMBODIMENTS

### First Embodiment

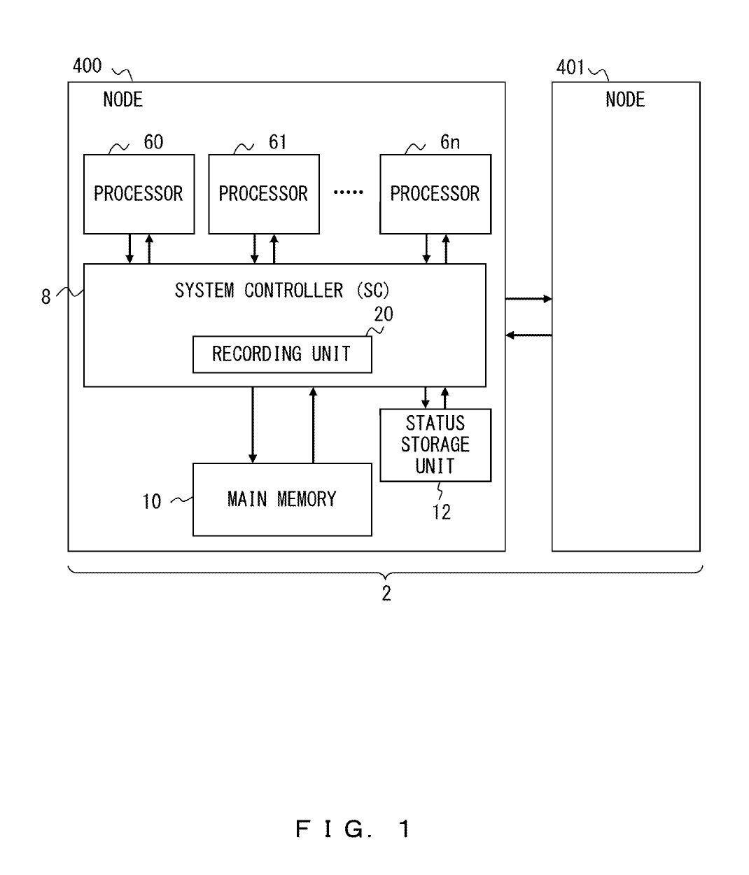

FIG. 1 will be referred to so as to explain a first embodiment. FIG. 1 illustrates an example of an information processing apparatus according to the first embodiment.

This information processing apparatus 2 is an example of an information processing apparatus according to the present disclosure. The information processing apparatus 2 in FIG. 1 is a system including a plurality of nodes 400 and 401. In this system, when the node 400 is assumed to be a subject node, the node 401 is a different node connected to the subject node 400.

The node 400, which is only exemplary, includes a plurality of processors 60, 61, . . . , 6n, a system controller (SC) 8, a main memory 10, and a status storage unit 12. The processors 60, 61, . . . , 6n and the SC 8 function as the memory control unit of the main memory 10, and also function as a reading unit that reads information from the status storage unit 12, a writing unit that writes data, and a recording controlling unit that records and deletes information in the recording unit 20. The main memory 10 employs the configuration of, for example, a DRAM (Dynamic Random Access Memory).

The status storage unit 12 is disposed in the node 400, and is connected to the SC 8. The status storage unit 12 is disposed external to the SC 8, and stores information indicating statuses of a plurality of cache lines. Statuses of a plurality of cache lines can be read by one reading operation from the status storage unit 12.

The SC 8 includes the recording unit 20. This recording unit 20 is provided to the SC 8 in at least one node such as, for example, the node 400, and employs a configuration of a storage medium such as a SRAM (Static RAM) or the like. In the SC 8, the recording unit 20 records part or all of the pieces of status information stored in the status storage unit 12.

The information processing apparatus 2 reads information from the status storage unit 12 in response to a request. In such a case, one reading operation performed on the status storage unit 12 can obtain status information of a plurality of cache lines. When the statuses of cache lines obtained from the status storage unit 12 are all invalid statuses or all shared statuses for different nodes 401, the statuses obtained from the status storage unit 12 are recorded in the recording unit 20.

The different node 401 may employ the same configuration as the node 400 described above. Also, as long as data can be transmitted and received between the node 400 and the different node 401, they may employ different configurations.

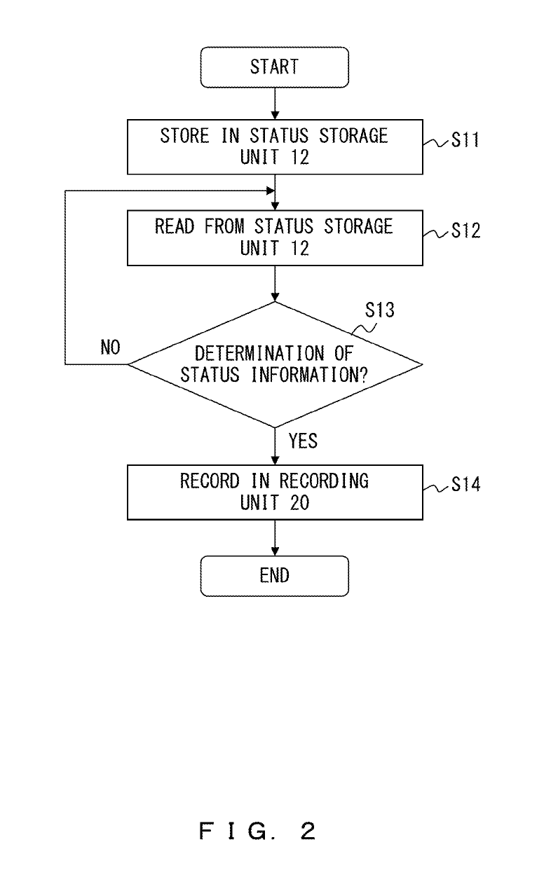

Next, FIG. 2 will be referred to so as to explain a processing sequence of the information processing apparatus 2. FIG. 2 illustrates an example of a sequence of information processing.

The processing sequence in FIG. 2 is an example of a method of controlling a memory according to the present disclosure, and is a processing sequence of a method of controlling a memory of the information processing apparatus 2.

In the processing sequence, as illustrated in FIG. 2, the system controller (SC) 8 stores status information of a plurality of cache lines in the status storage unit 12 (step S11). As a result of this, results of memory accesses are stored sequentially. Next, the SC 8 reads information from the status storage unit 12 in response to a request so as to read the status information of the cache line that is to be stored in the status storage unit 12 (step S12). As described above, one reading operation can read status information of a plurality of cache lines from the status storage unit 12.

Next, the SC 8 determines whether or not the status information of a plurality of cache lines obtained by the reading operation performed on the status storage unit 12 indicates all invalid statuses or all shared statuses for different nodes (step S13).

When all pieces of status information of a plurality of cache lines are invalid statuses or shared statuses (YES in step S13) for all different nodes in the determination of status information (step S13), the status information read in step S12 is recorded in the recording unit 20 (step S14). When not all pieces of status information of a plurality of cache lines are invalid statuses or shared statuses (NO in step S13) for all different nodes, the process returns to step S12. After the process in step S13, status information read in step S12 is recorded in the recording unit 20, and the process in FIG. 2 is terminated.

When one of the statuses of different nodes of cache lines obtained in step S12 is not an invalidated status or a shared status, status information obtained in step S12 is not recorded in the recording unit 20.

The present embodiment achieves the following effects.

(1) It is possible to reduce latency in memory reading operations.

(2) In the information processing apparatus 2 that constitutes a large-scale system, the average latency in memory reading operations of the large-scale system is reduced.

(3) The reduction in the average latency in memory reading operations contributes to an increase in speed of memory accessing.

Also, in the present embodiment, when there is a request from the different node 401 to the subject node 400, the node 400 determines the content of the request from the different node 401. When the request from the different node 401 is a request that caches data eventually and the recording unit 20 includes the status of this request, that status is deleted from the recording unit 20. This configuration also contributes to the reduction in latency reading operations.

### Second Embodiment

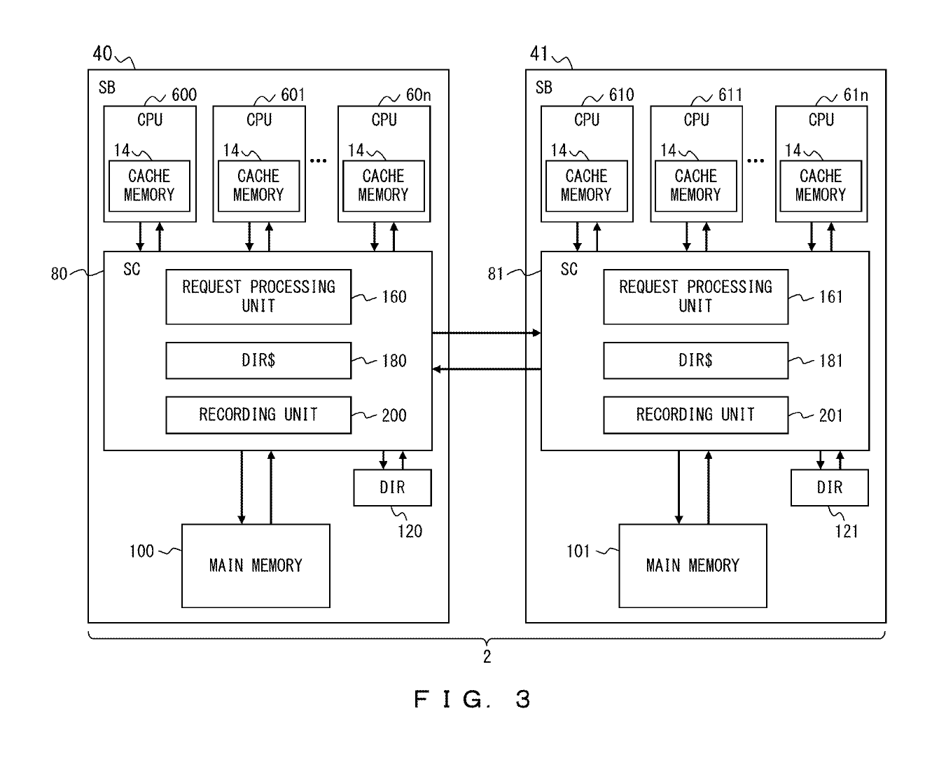

FIG. 3 will be referred to so as to explain a second embodiment. FIG. 3 illustrates an example of an information processing apparatus.

The information processing apparatus 2 illustrated in FIG. 3 is an example of an information processing apparatus according to the present disclosure. The information processing apparatus 2, as illustrated in FIG. 3, includes a first system board (SB) 40 and a second system board (SB) 41 as examples of a plurality of system boards (SBs). Each of the SBs 40 and 41 constitutes a node, and when SB 40 is assumed to be a subject node, the SB 41 is assumed to be a different node (a node different from the subject node).

The SB 40 includes a plurality of central processing units (CPUs) 600, 601, . . . , and 60n, a system controller (SC) 80, a main memory 100, and a DIR 120. The SC 80 is connected to the SB 41. The SB 41 includes a plurality of CPUs 610, 611, . . . , and 61n, an SC 81, a main memory 101, and a DIR 121.

Each of the CPUs 600, 601, . . . , 60n and 610, 611, . . . , 61n includes a cache memory 14. Data read from the main memories 100 and 101 is written to each cache memory 14 to utilize the data in order to increase speed in memory accessing.

The SC 80 is connected to the CPUs 600, 601, . . . , and 60n, the main memory 100, the DIR 120 of the subject node, i.e., the SB 40 including the SC 80 itself, and is also connected to a different node, i.e., the SB 41, so as to perform control for securing cache coherency (coherency control) between the subject node (SB 40) and a different node (SB 41). Specifically, the SC 80 performs control for securing the coherency of the contents between the cache memory 14 and the main memory 100. The SC 81 performs coherency control between the SB 41 and the SB 40 similarly. The main memories 100 and 101 are units for storing data.

Hereinafter, elements included in the SB 40 will be explained.

The DIR 120 is an example of a first status storage unit, and stores statuses (MESI: Modified Exclusive Shared Invalid) of the cache lines of the main memory 100 of the node including the DIR 120 itself so as to manage the information on the statuses. “M (Modified)” is a modified status indicating that the cache memory 14 of each CPU stores information different from that in the main memory 100. “E (Exclusive)” is an exclusive status indicating that the cache memory 14 and the main memory 100 store the same information. “S (Shared)” is a shared status indicating that the same cache line is in both the cache memory 14 and the main memory 100 and that the cache memory 14 and the main memory 100 store the same information. “I (Invalid)” is an invalid status indicating that the cache line is invalid.

The SC 80 includes a request processing unit 160, a DIR$ 180, and a recording unit 200.

The DIR$ 180 is an example of a second status storage unit, and records part of the information stored in the DIR 120.

The recording unit 200 is an example of a block that records part of the information recorded by the DIR 120. In the recording unit 200, the fact that information stored in the main memory 100 controlled by the node including the recording unit 200 itself is not possessed by different nodes is recorded, and only a shared status (S) and an invalid status (I) described above are recorded.

The SB 40 has been explained for the above configuration. However, the SB 41 similarly includes a plurality of CPUs 610, 611, . . . , 61n, and a system controller (SC) 81, a main memory 101, and a DIR 121. Also, each CPU includes the cache memory 14, and the SC 81 includes a request processing unit 161, a DIR$ 181, and a recording unit 201, all of which have the same functions as described above, and thus explanations of them will be omitted.

Accordingly, the information processing apparatus 2 illustrated in FIG. 3 can read statuses of a plurality of cache lines by reading the DIR 120 or 121. In the information processing apparatus 2, statuses are compressed so as to be registered in the recording unit 200 by using a small amount of data.

The information processing apparatus 2 including the DIRs 120 and 121 are provided with the recording units 200 and 201, and the hitting ratio for reading requests is increased so as to reduce the average latency in memory reading operations according to a method of recording information in the recording units 200 and 201.

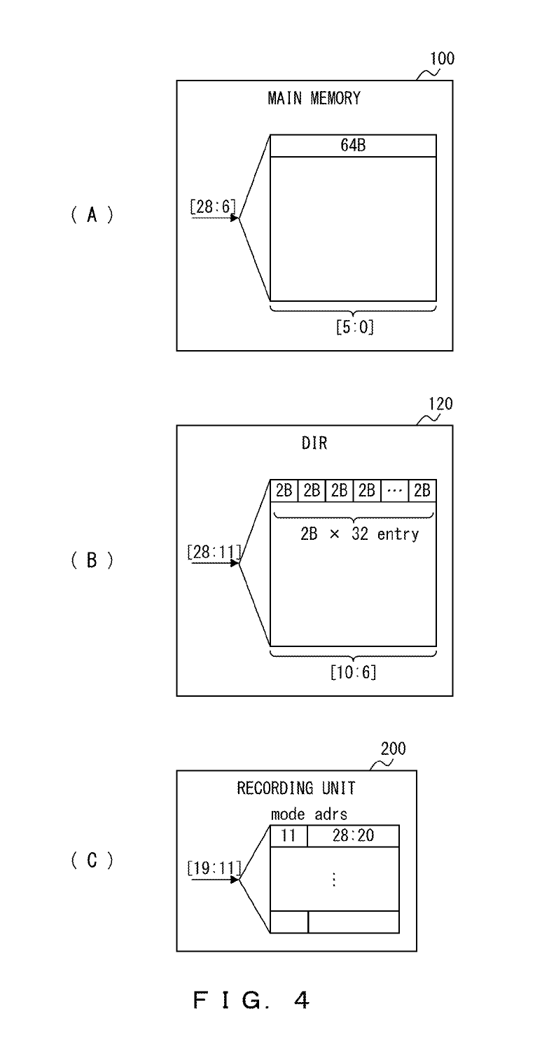

Next, FIG. 4 will be referred to so as to explain the main memory 100, the DIR 120, and the recording unit 200. FIG. 4A illustrates a configuration example of a main memory, FIG. 4B illustrates a configuration example of a DIR, and FIG. 4C illustrates a configuration example of a recording unit.

As illustrated in, for example, FIG. 4A, it is assumed that the main memory 100 has the inside-node address of 29[bit] [28:0], and has 64[B] as the size per cache line address of the main memory. Accordingly, the main memory 100 employs a configuration in which an address is specified in the main memory 100 by higher bits [28:6] of the inside-node address and 64 bytes of data stored at the address [28:6] is accessed.

As illustrated in, for example, FIG. 4B, the DIR 120 employs a configuration in which there is a 2-byte area for one cache line address. The status of the corresponding cache line address is stored in a 2-byte area in the DIR 120. By accessing the DIR 120 by using higher bits [28:11] of an inside-node address so as to read information stored in an area corresponding to address [28:11], the statuses of a plurality of cache line addresses can be read by one reading operation performed on the DIR 120. The statuses read from the DIR 120 are decoded, for example, at a lower bit address [10:6] as an inside-node address, and the area corresponding to the address in the main memory 100 is used.

As illustrated in, for example, FIG. 4C, the recording unit 200 has fields (areas) of mode and address (adrs). Mode is information indicating the statuses of all thirty-two entries read from the DIR 120. Also, the address corresponds to higher bits of the inside-node address. When the thirty-two entries read from the DIR 120 are all “Invalid”, all “Shared”, or include both “Invalid” and “Shared”, the corresponding modes and addresses are registered in the recording unit 200.

Also, the recording unit 200 is accessed by address [19:11], and the mode and address recorded in the area corresponding to address [19:11] are read from the recording unit 200.

(1) Using Data Read from the DIR 120 for a Request

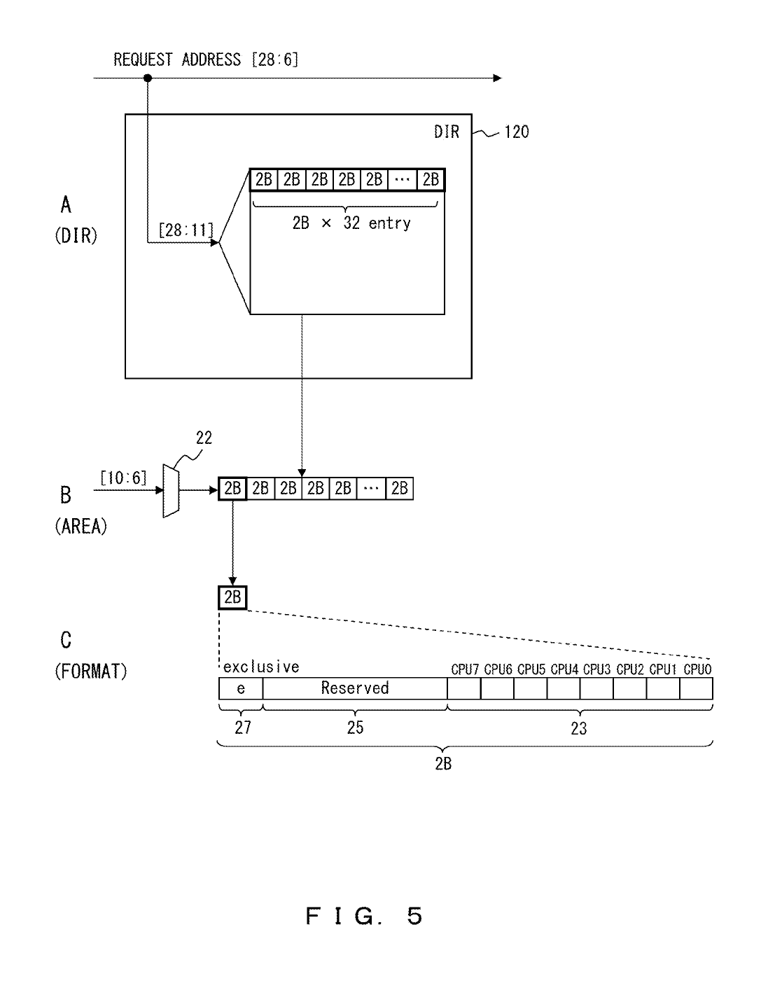

FIG. 5 will be referred to so as to explain the DIR 120 uses data read from the DIR 120 for a request. FIG. 5 illustrates usage of data read from the DIR 120.

FIG. 5A illustrates a configuration of the DIR 120. FIG. 5B illustrates areas of the DIR. When a request is made for data at request address [28:6], and the DIR 120 is read, higher bits [28:11] of the request address are used for reading the DIR 120. When the DIR 120 is read, thirty-two entries corresponding to address [28:11] can be read, and the read entries are decoded by a decoder 22 on the basis of lower bit address [10:6] of the request address, and the area corresponding to the request address is determined so that information stored in that area is used.

FIG. 5C illustrates a format of one entry. In this format, a plurality of holding sections 23, 25, and 27 are set. In the holding section 23, fields for CPU 0, CPU 1, CPU 2, . . . , CPU 7 are set so that they correspond to the eight CPUs 600, 601, . . . , 607 included in the information processing apparatus 2 illustrated in FIG. 3, and each of the fields in the holding section 23 stores the cache status of the corresponding CPU. When the corresponding CPU has cached information, the field for the CPU contains “1”, and when the corresponding CPU is has no cached information, the field for that CPU contains “0”. The holding section 25 is set as a reserved field. Also, in the holding section 27, exclusive-right information is stored. When the cache status is exclusive, the field for the exclusive-right information contains “1”, and otherwise, it contains “0”.

This configuration and the usage of areas also apply to the DIR 121.

(2) Recording in DIR$ 180 after Reading Information from DIR 120

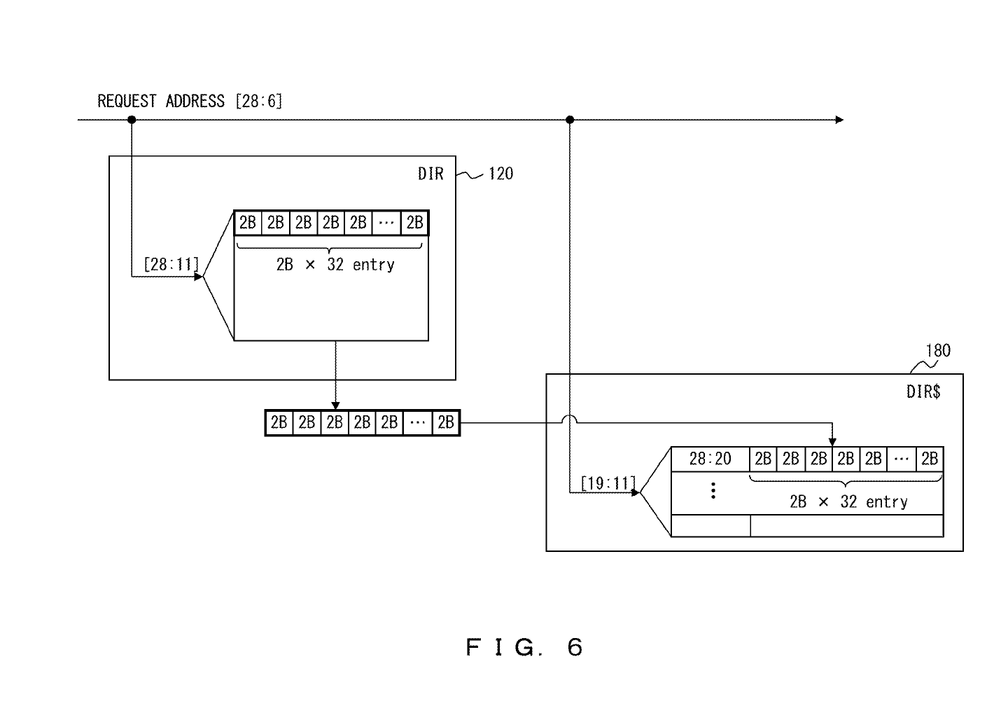

FIG. 6 will be referred to so as to explain recording status information in the DIR$ 180 after reading information from the DIR 120. FIG. 6 illustrates recording of statuses in the DIR$ 180 after reading information from the DIR 120.

The thirty-two entries stored in areas in the DIR 120 that correspond to address [28:11] of request address [28:6] are read from the DIR 120. Next, higher address [28:20] of request address [28:6] and data read from areas in the DIR 120 corresponding to request address [28:11] are written to areas in the DIR$ 180 that correspond to address [19:11] among request address [28:6]. Thereby, the statuses of the thirty-two entries are managed by the DIR$ 180 for one address.

(3) Recording Information in the Recording Unit 200 after Reading Information from the DIR 120

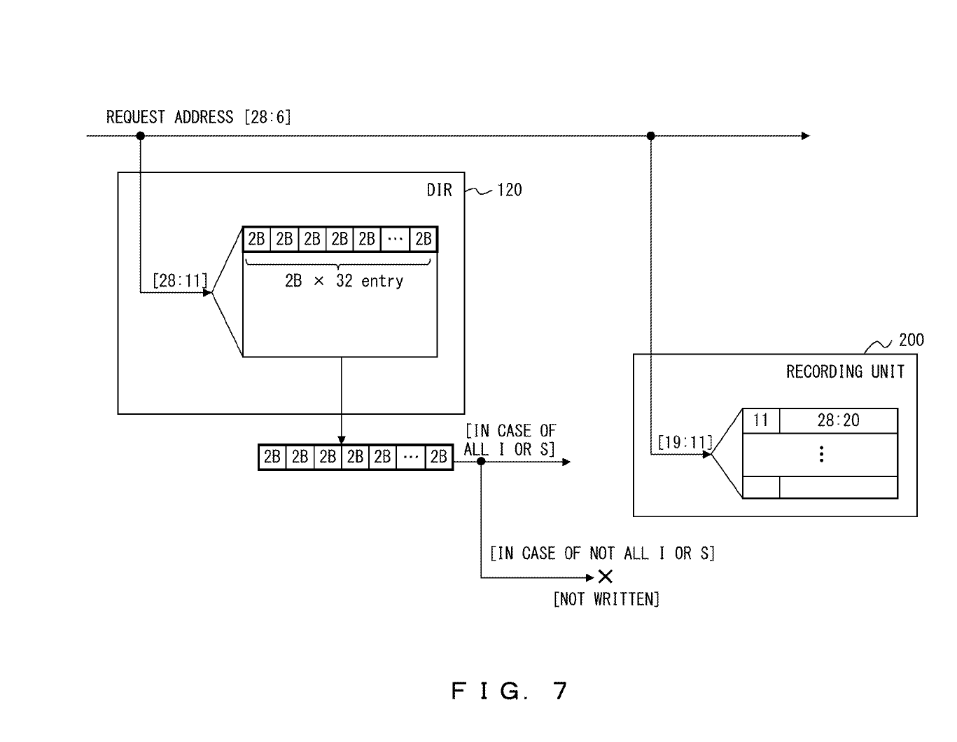

FIG. 7 will be referred to so as to explain recording of information in the recording unit 200 after reading information from the DIR 120. FIG. 7 illustrates recording of information in the recording unit 200 after reading information from the DIR 120.

The thirty-two entries stored in areas in the DIR 120 that correspond to address [28:11] of request address [28:6] are read. When all of the thirty-two entries read from the DIR 120 are Invalid or when all of them are Shared, the modes corresponding to the statuses of all of the entries read from the DIR 120 and higher address [28:20] of the request address are written to areas in the recording unit 200 that correspond to address [19:11] of request address [28:6]. Thereby, it is possible to use modes for managing all of the thirty-two entries for one address, reducing the size of the recording unit 200 with respect to the DIR$ 180.

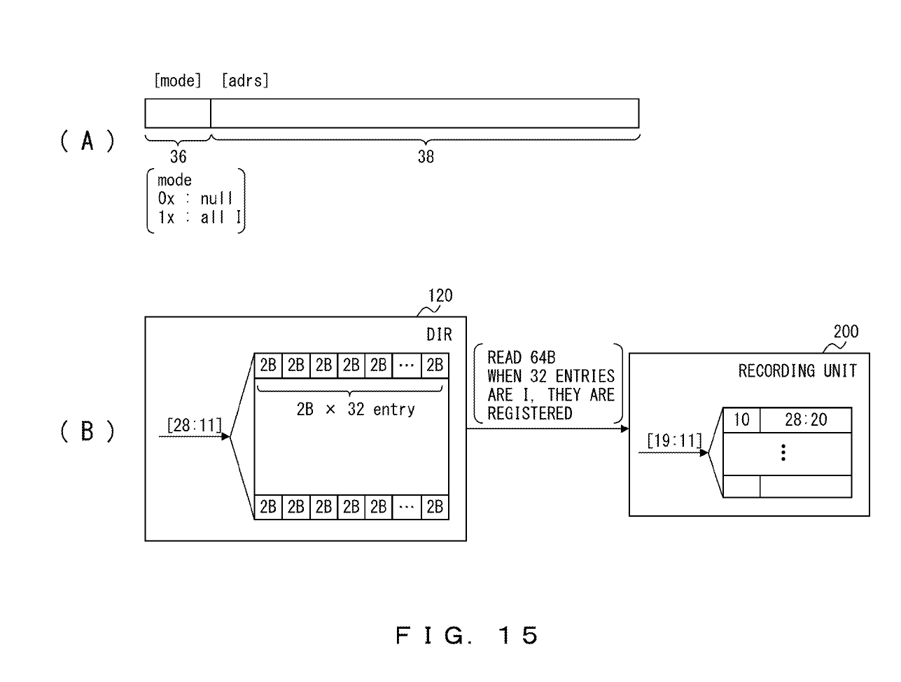

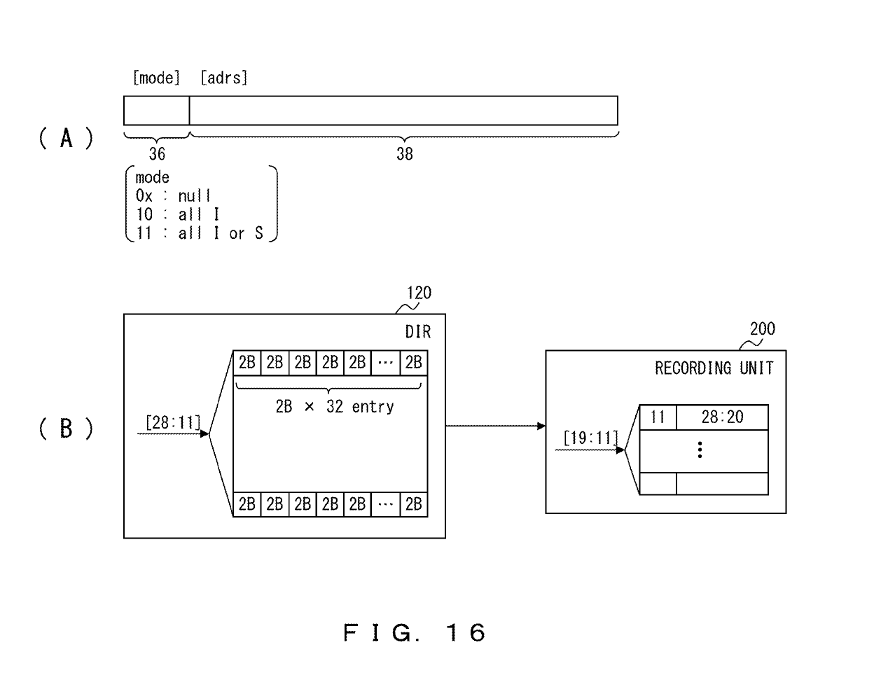

When information is read from the DIR 120 in response to a request (access request), data for the thirty-two entries can be read from the DIR 120. The statuses of all of the thirty-two entries read from the DIR 120 are determined, and when the statuses of all of the thirty-two entries read from the DIR 120 are “Invalid”, when all of them are “Shared”, or when they include both “Invalid” and “Shared”, information of the modes corresponding to the statuses of the read entries and higher address [28:20] of the request address are written to areas in the recording unit 200 specified by address [19:11] of address [28:11] that was used for accessing the DIR 120. A method of using the moods is as described in FIGS. 15 and 16.

Accordingly, information indicating that all of the statuses of the thirty-two entries are “I”, all of them are “S”, or they include both “I” and “S”, is stored in the recording unit 200. The recording unit 200 does not store data that is held by the DIR 120, and accordingly, the size thereof can be reduced greatly in comparison to the DIR$ 180. Further, it can manage the statuses of the thirty-two entries. When at least one of the statuses of the thirty-two entries is not “Invalid” or “Shared” as a result of reading the DIR 120, no information is stored in the recording unit 200.

(4) Example of Using Data Read from the Recording Unit 200

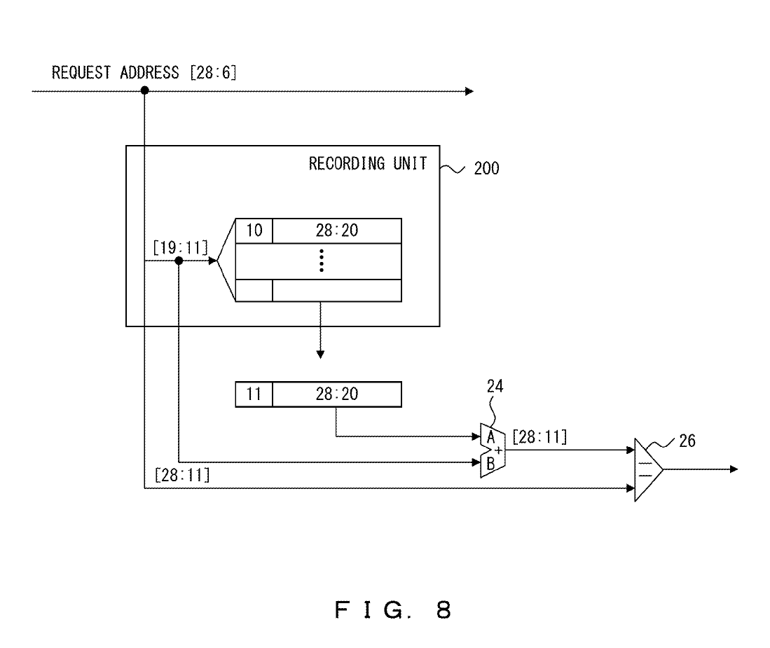

FIG. 8 will be referred to so as to explain an example of using data read from the recording unit 200. FIG. 8 illustrates an example of using data read from the recording unit 200.

Data in the area in the recording unit 200 corresponding to address [19:11] of request address [28:6] is read. Higher bits [28:20] of an address included in the data read from that area are added to address [19:11] by using an adder 24 so as to generate address [28:11]. Next, a comparator 26 is used for comparing the address generated by the adder 24 with address [28:11] of request address [28:6]. When they are equal, this means a hit. In the example illustrated in FIG. 8, because the mode is 10, it is recognized that CPUs of different nodes managed by the DIR 120 do not hold data as the target of the read request. The value of a mode indicates a status, and when a status is “Invalid”, the mode value is “10”, and when a status is “Invalid” or “Shared”, the mode value is “11”. Values of modes are recorded in the recording unit 200. This applies to the recording unit 201 as well.

(5) Comparison Between the DIR 120, the DIR$ 180, and the Recording Unit 200

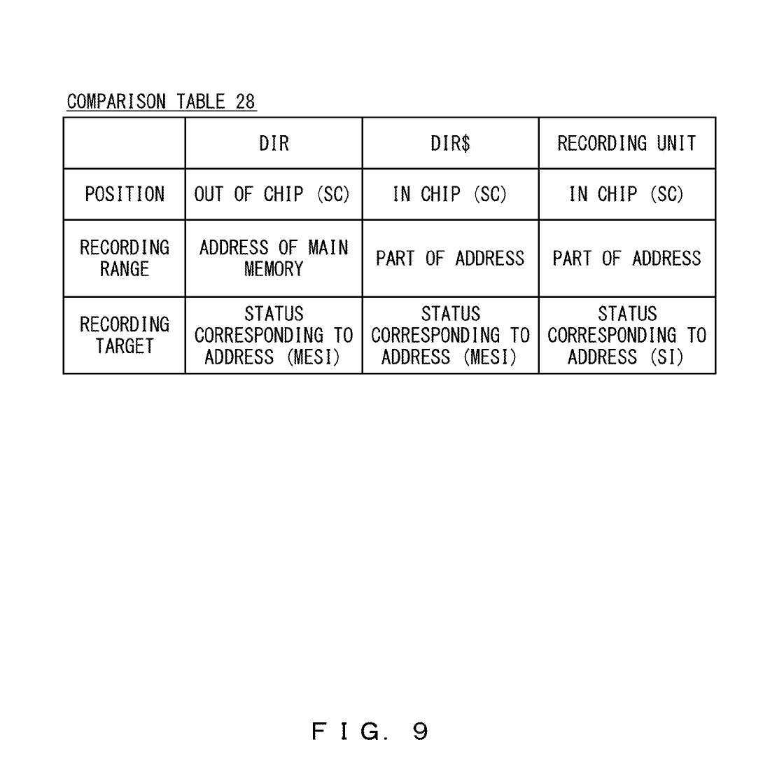

FIG. 9 will be referred to so as to explain a comparison between the DIR 120, the DIR$ 180, and the recording unit 200. FIG. 9 illustrates a comparison between the DIR 120, the DIR$ 180, and the recording unit 200.

As illustrated in FIG. 9, the DIR 120 is located external to the SC 80, that is, external to the chip of the SC 80, while the DIR$ 180 and the recording unit 200 are located within the SC 80, that is, within the chip of the SC 80.

The recoding range of the DIR 120 covers addresses of the main memory 100, while the recording range of the DIR$ 180 and the recording unit 200 covers part of the addresses.

The DIR 120 and the DIR$ 180 store statuses corresponding to addresses (MESI). The recording unit 200 stores statuses corresponding to addresses (SI).

Next, explanations will be given for recording of information in the recording unit 200 and deletion of information from the recording unit 200.

(a) Recording Information in the Recording Unit 200

As a method of recording information in the recording unit 200, reference is made to operations in which the CPU 600 issues a read request to the main memory 100 in the SB 40 (the node of the CPU 600).

It is now assumed as an example that the size of a cache line that the CPU 600 caches in the cache memory 100 of itself is 64[Bytes]. When each entry of the DIR 120 has an area of two [bytes] for one cache line, 64[bytes] (2[bytes]×32 [entries]) of data is read by one reading operation performed on the DIR 120.

When there is a mishit in the cache memory 14 of the CPU 600 in response to a read request, the CPU 600 issues a read request to the request processing unit 160 in the SC 80 that manages the main memory 100 as the request target. The request processing unit 160 searches the DIR$ 180 and the recording unit 200 in the SC 80. When there is a mishit in both the DIR$ 180 and the recording unit 200, the request processing unit 160 performs a reading operation on the DIR 120. Thirty-two entries may be read by one reading operation performed on the DIR 120. When it has been determined that the caching operations have been performed with all of the thirty-two entries obtained as results of the reading performed on the DIR 120 being “Invalid”, all of them being “Shared”, or all of them including both “Shared” and “Invalid”, that fact is recorded in the recording unit 200 (FIG. 7). Information recorded in the recording unit 200 may also be recorded in the DIR$ 180. When at least one of the thirty-two entries read from the DIR 120 indicates that the status is not “Invalid” or “Shared” in a different node (SB 41), preventing storing of statuses in the recording unit 200, status information may be stored in the DIR$ 180.

As described above, it is possible to compress the statuses of the thirty-two entries so as to record in the recording unit 200 a fact that data of addresses over a wide range has not been cached by different nodes. Because the recording unit 200 is capable of managing information using a smaller volume of data than the DIR$ 180 (FIG. 6 and FIG. 7), it is possible to increase the hit rate of read requests by assigning part of the volume of the DIR$ 180 to the recording unit 200, to extend the range to be managed. Accordingly, it is possible to increase the hit rate for read requests by employing the recording unit 200, and unnecessary reading operations from the DIR 120 can be suppressed so as to reduce latency for read requests. Because the DIR$ 180 and the recording unit 200 are in the SC 80, accesses to the recording unit 200 are faster than those to the DIR 120, located external to the SC 80.

(b) Deletion from the Recording Unit 200

Explanations will be given for an operation in which the CPU 610 of a different node, a node other than the SB 40, issues a read request to the main memory 100 in the SB 40 as an operation of deleting information from the recording unit 200.

It is assumed that the size of a cache line that the CPU 610 included in the SB 41 caches to the cache memory 14 of itself is 64[bytes], an entry in the DIR 120 has an area of 2[bytes] for one cache line, and 64[bytes] (=2[bytes]×32[entries]) of data is read by one reading operation performed on the DIR 120.

When there is a mishit in the cache memory 14 of the CPU 610 in response to a read request of the CPU 610, the CPU 610 issues a read request to the request processing unit 160 in the SC 80 that manages the main memory 100 as the request target. When the read request is a request that eventually caches data in an “Exclusive” status and the address as the target of the read request is included in a cache line recorded in the recording unit 200, the CPU 610 in the SB 40 managed by the recording unit 200 newly caches data. Thereby, data expressing “Invalid” that indicates that the CPU 610 has not cached data is deleted from the recording unit 200.

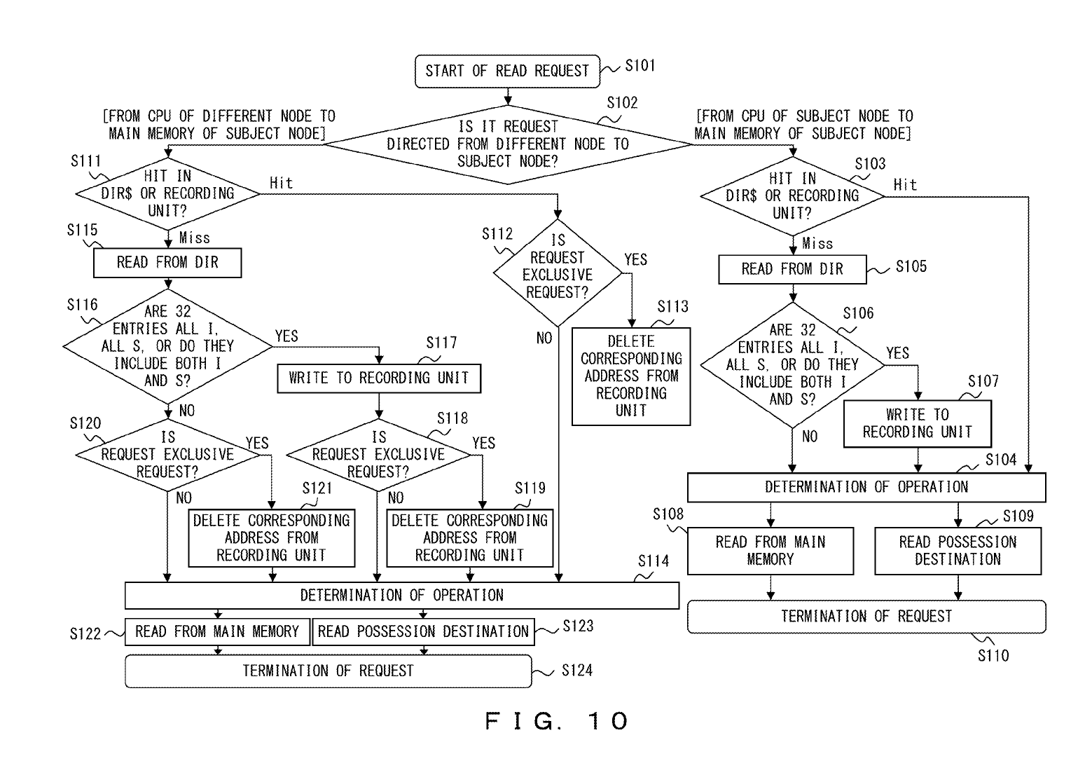

Next, FIG. 10 will be referred to so as to explain an accessing process. FIG. 10 illustrates an example of an accessing process. It is assumed hereinafter that the system controller 80 in the SB 40 executes the process in FIG. 10.

The process sequence illustrated in FIG. 10 is an example of a method of controlling a memory according to the present disclosure. As illustrated in FIG. 10, when a read request has started (step S101), the system controller 80 that has received a read request determines whether the received read request is directed to the SB 40 (i.e., the node including the SB 40 itself) from the SB 41 (i.e., a different node).

When the received read request is not directed to the node including the SC 80 itself from a different node, the received read request is a request directed to the memory in the node including the SC 80 itself from the CPU in the node including the SC 80 itself, and the system controller 80 searches the DIR$ 180 and the recording unit 200 (step S103). When there is a hit in either DIR$ 180 or the recording unit 200 (Hit), the reading operation in step S108 or S109 is determined (i.e., operation determination) (step S104).

When there is a hit in neither the DIR$ 180 nor the recording unit 200, i.e., when there is amiss (Miss), the system controller 80 reads information from the DIR 120 of the node including the SC 80 itself (step S105), reads recorded entries, and determines whether all of the read thirty-two entries are “I”, all of them are “S”, or they include both “I” and “S” (step S106). When all of the read thirty-two entries are “I”, all of them are “S”, or they include both “I” and “S” (YES in step S106), the system controller 80 writes necessary information to the recording unit 200 (step S107), and the process proceeds to the operation determination (step S104). When at least one of the thirty-two entries is neither “I” nor “S” (NO in step S106), the process proceeds to the operation determination (step S104).

After the operation determination (step S104), a reading operation from the main memory (step S108) and a reading operation from the possession destination (step S109) are performed, and the process of a read request is terminated (step S110). A reading operation from a possession destination is a search performed by a CPU that has cached the data.

If it has been determined in step S102 that the received request is directed to the node including the SC 80 itself from a different node, it is a request directed to the main memory 100 in the node including the SC 80 itself from the CPU in a different node (the SB 41), and the system controller 80 searches the DIR$ 180 and the recording unit 200 (step S111). When there is a hit in either the DIR$ 180 or the recording unit 200 (same as step S103), the system controller 80 determines whether or not the request is an exclusive request (step S112). When the request is an exclusive request (YES in step S112), the system controller 80 deletes information recorded at the address corresponding to the read request (corresponding address information) of the recording unit 200 (step S113). When the request is not an exclusive request (NO in step S112), the process executes the determination of a reading operation (i.e., operation determination) in step S122 or step S123 (step S114), which will be explained later.

When there is a hit in neither the DIR$ 180 nor the recording unit 200 in step S111, i.e., when there is a miss, the system controller 80 reads information in the DIR 120 (step S115), and determines whether all of the read thirty-two entries from the DIR 120 are “I”, all of them are “S”, or they include both “I” and “S” (step S116). When all of the read thirty-two entries are “I”, all of them are “S”, or they include both “I” and “S” (YES in step S116), the system controller 80 writes necessary information to the recording unit 200 (step S117), and it is determined whether or not the request is an exclusive request (S118). When the request is an exclusive request (YES in step S118), the system controller 80 deletes information recorded at the address corresponding to the read request (corresponding address information) of the recording unit 200 (step S119), and the process proceeds to the operation determination (step S114). When the request is not an exclusive request (NO in step S118), the process executes the operation determination (step S114).

When at least one of the thirty-two entries read from the DIR 120 is not “I” or “S” (NO in step S116), the system controller 80 determines whether or not the request is an exclusive request (step S120). When the request is an executive request (YES in step S120), the system controller 80 deletes information at the address corresponding to the read request in the recording unit 200 (step S121), and the process executes the operation determination (step S114). When the request is not an exclusive request (NO in step S120), the process executes the operation determination (step S114).

After the operation determination (step S114), a reading operation from the main memory 100 (step S122) and a reading operation from the possession destination (step S123) are performed, and the process of a read request is terminated (step S124).

As described above, in the information processing apparatus 2 that constitutes a large-scale system, the average latency in memory reading operations can be reduced.

### EXAMPLE

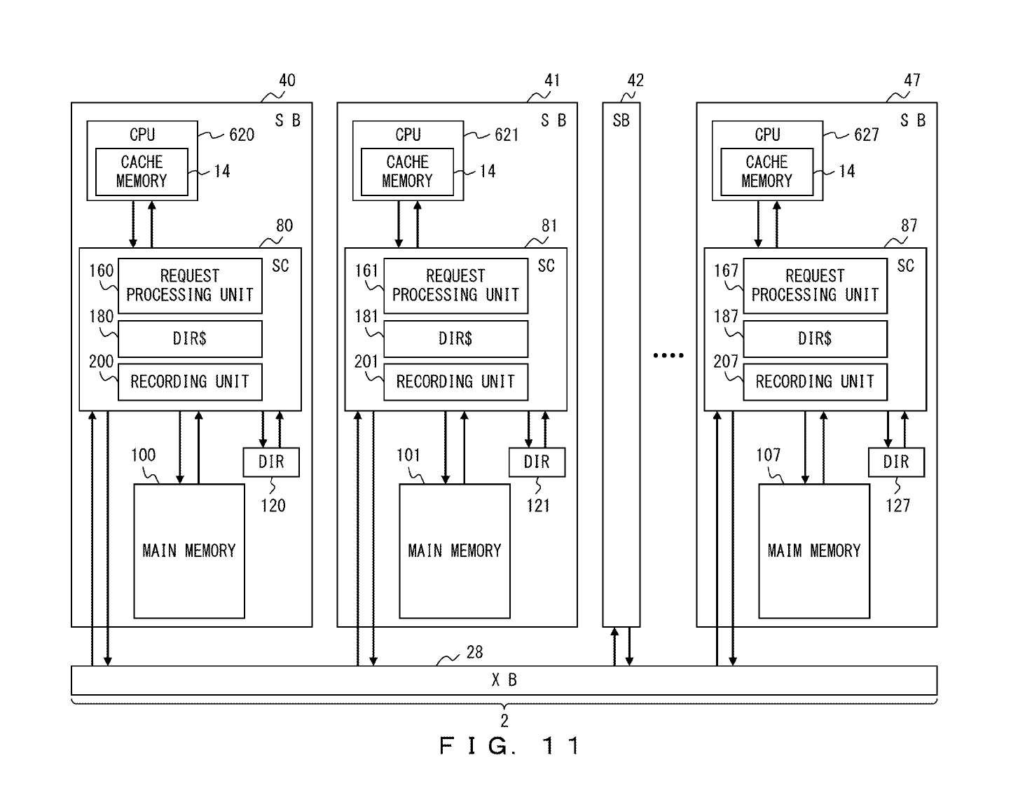

FIG. 11 will be referred to so as to explain an example. FIG. 11 illustrates an example of an information processing apparatus. In FIG. 11, the same elements as those in FIG. 3 are denoted by the same symbols.

The information processing apparatus 2 illustrated in FIG. 11 includes eight pairs of SBs 40, 41, 42, . . . , and 47 as system boards that constitute a plurality of nodes, and the SBs 40, 41, 42, . . . , and 47 are connected to a crossbar (XB) 28. In the information processing apparatus 2 illustrated in FIG. 11, when the SB 40 is assumed to be a subject node, the SBs 41 through 47 constitute a plurality of different nodes, and they are connected to each other via the XB 28. The SBs 40, 41, 42, . . . , and 47 each include eight CPUs 620, 621, . . . , and 627. In the explanations of the respective elements below, the SB including those respective elements is referred to as a “subject node”, and SBs other than that node are referred to as “different nodes”.

In the system controller 80, the request processing unit 160, the DIR$ 180, and the recording unit 200 are provided, and external to the SC 80, the DIR 120 is provided.

The request processing unit 160 determines processes of requests in accordance with the types of the requests and the statuses of caches. The DIR$ 180 holds part of the information held by the DIR 120. In the recording unit 200, information indicating that all or part of the information held by the main memory 100 controlled by the subject node (SB 40) is not possessed by cache memories of different nodes is recorded.

The DIR 120 holds information indicating, for example, under what status each CPU has cached all or part of the information held by the main memory 100 in the subject node. The DIR 120 may be configured in an area as a part of the main memory 100.

The recording unit 200 may record information in the same CPU that is managed by the DIR 120, or may record information in a different CPU.

It is assumed that the cache line size for each of the CPUs 620, 621, . . . , and 627 caching information in the cache memory 14 of themselves in the information processing apparatus 2 is 64[bytes] as an example. When an entry of the DIR 120 has an area of 2[bytes] for one cache line, 64[bytes] of data can for example be read in a reading operation performed in the DIR 120.

Cache statuses of the cache memories 14 included in the CPUs 620, 621, . . . , and 627 are managed in accordance with the so-called MESI protocol (Modified, Exclusive, Shared, and Invalid). In the DIR 120 and the DIR$ 180, statuses of cache memories are managed by “Exclusive”, “Shared, and “Invalid”.

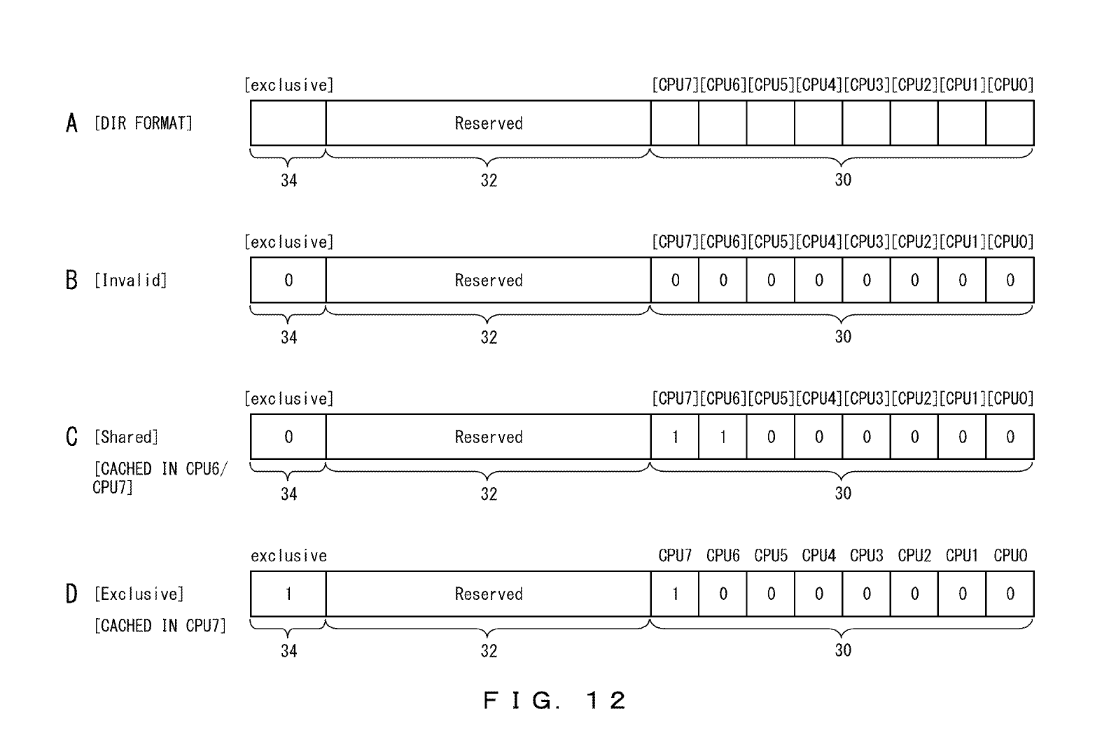

The format of the DIR 120 has a plurality of holding sections 30, 32, and 34 as illustrated in FIG. 12A. The holding section 30 has fields for CPU0, CPU1, CPU2, . . . , CPU7 that correspond to the eight CPUs 620, 621, . . . , and 627 included in the information processing apparatus illustrated in FIG. 11, and each field of the holding section 30 store the cache status of the corresponding CPU. When the corresponding CPU has cached information, the CPU field contains “1”, and when the corresponding CPU has not cached information, the CPU field contains “0”. The holding section 32 is set as a reserved field. In the holding section 34, exclusive information is stored. In the field of exclusive information, “1” is stored when the cache status is exclusive, and “0” is stored in other cases.

In the DIR 120, when the status is “Invalid”, i.e., when none of the CPUs have cached information, “CPU0=0”, . . . , “CPU7=0” are stored in the holding section 30, and “0” is stored in the holding section 34, as illustrated in FIG. 12B.

When the status is “Shared”, i.e., when a plurality of CPUs have cached the same information, “1” is stored in areas of the holding section 30 corresponding to the CPUs that have cached the information, and “0” is stored in the holding section 34. When, for example, CPU6 and CPU7 have cached information, “CPU0=0” through “CPU5=0” and “CPU6=1” and “CPU7=1” are stored in the holding section 30, and “0” is stored in the holding section 34, as illustrated in FIG. 12C.

When the status is “Exclusive”, i.e., when only one CPU has cached information, “1” is stored in the field in the holding section 30 that corresponds to the CPU having cached the information, and “1”, which indicates “Exclusive”, is stored in the holding section 34. When, for example, only CPU7 has cached information, “CPU0=0” through “CPU6=0” and “CPU7=1” are stored in the holding section 30, and “1” is stored in the holding section 34, as illustrated in FIG. 12D.

### Operation Example 1

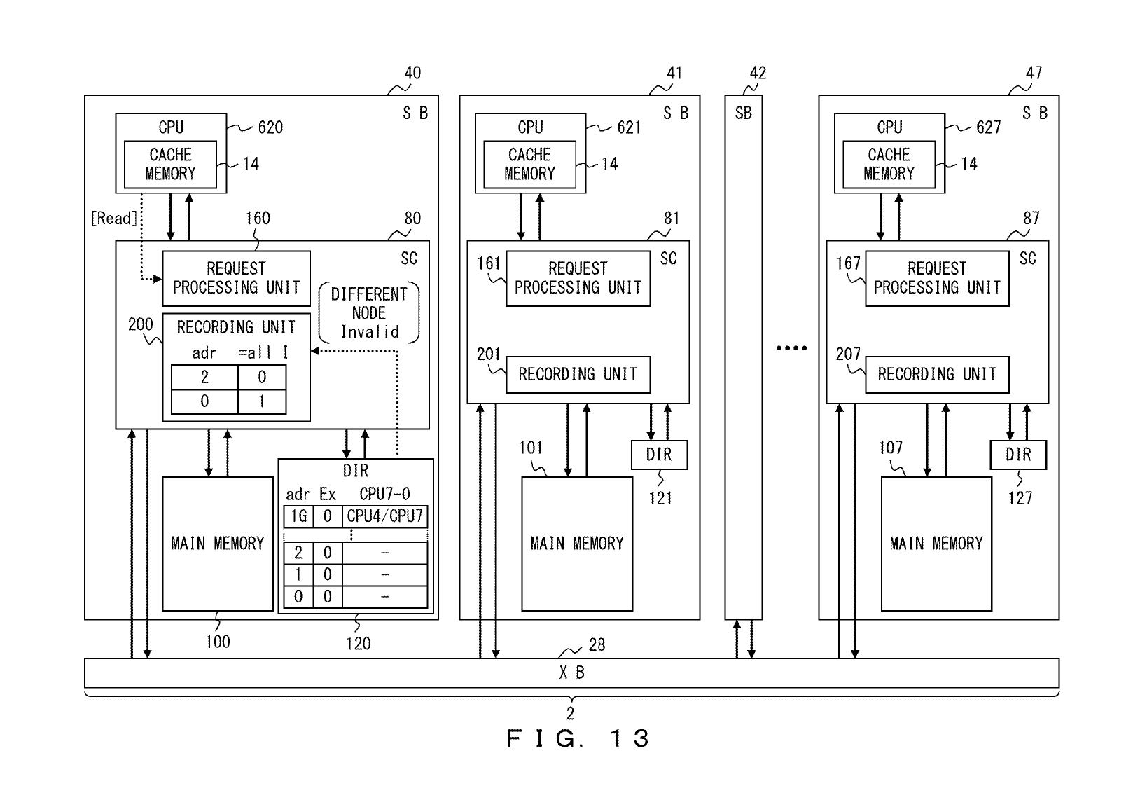

FIG. 13 will be referred to so as to explain operation example 1. FIG. 13 illustrates operation example 1 of the information processing apparatus. In FIG. 13, the same elements as those in FIG. 11 are denoted by the same symbols.

The information processing apparatus 2 illustrated in FIG. 13 includes eight pairs of SBs 40, 41, 42, . . . , and 47 as system boards that constitute a plurality of nodes, and the SBs, 41, 42, . . . , and 47 are connected to the XB 28. The SBs 40 through 47 include eight CPUs 620 through 627, respectively.

In the system controller 80, the request processing unit 160 and the recording unit 200 are provided, and external to the system controller 80, the DIR 120 is provided. In the recording units 200 through 207 of the SCs 80 through 87, information indicating that information stored in the main memories 100 through 107 controlled by the subject node is not possessed by cache memories of different nodes is recorded.

The DIRs 120 through 127 hold information indicating in what status each CPU has cached data in the main memories 100 through 107 of the subject nodes. The DIRs 120 through 127 may be configured in partial areas of the memories 100 through 107 of the subject nodes.

Issuance of a read request to the main memory 100 in the SB 40 performed by the CPU 620 and operations thereof in the information processing apparatus 2 will be explained. When there is a mishit for this read request in the cache memory 14 of the CPU 620, the CPU 620 changes the destination of the read request. The main memory 100 as the request target is managed by the SC 80, and the CPU 620 issues a read request to the request processing unit 160 in the SC 80 of the subject node.

The request processing unit 160 that has received a read request from the CPU 620 searches the DIR 120 and the recording unit 200. The request processing unit 160 reads information from the DIR 120, processes the request, and confirms the status of the address corresponding to the read request. Because the DIR 120 manages the CPU 620, the request processing unit 160 can recognize the status of the CPU 620. In such a case, when it has been recognized that the CPU 620 managed by the recording unit 200 has not cached data, the fact that that data becomes “Invalid” is recorded in the recording unit 200. In such a case, the status that becomes “Invalid” is recorded in the recording unit 200 in units of addresses. Other nodes also conduct these operations.

### Operation Example 2

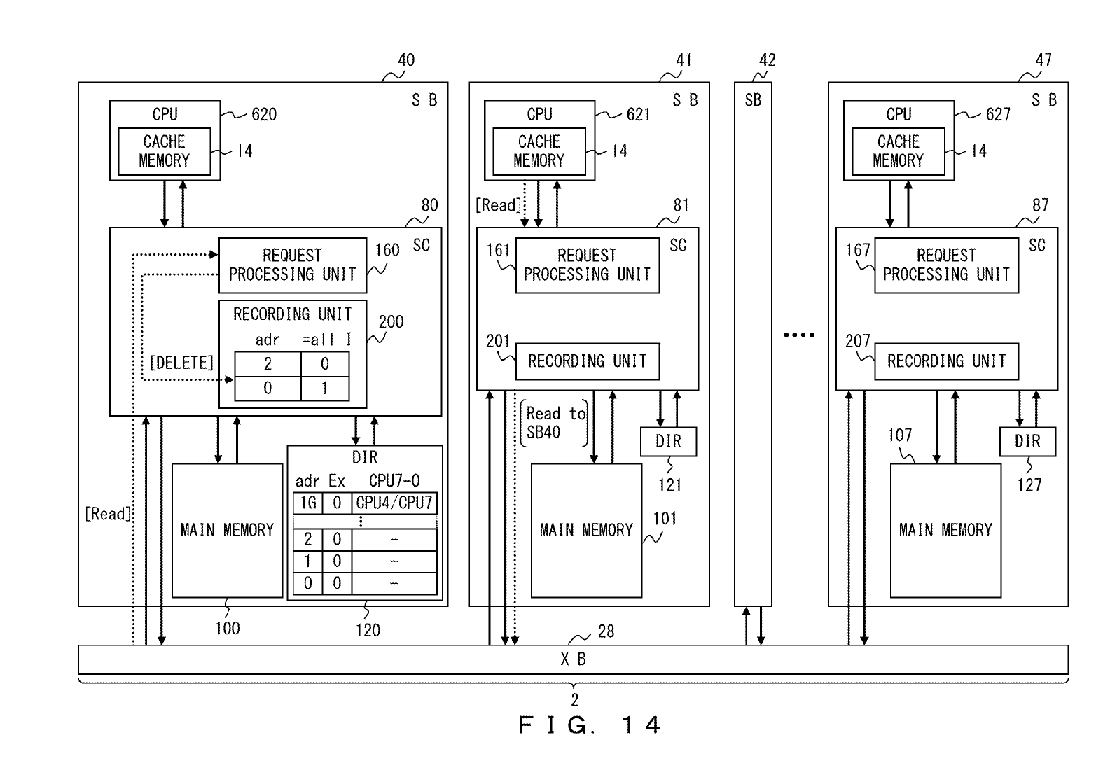

FIG. 14 will be referred to so as to explain operation example 2. FIG. 14 illustrates operation example 2 of the information processing apparatus. In FIG. 14, the same elements as those in FIG. 11 are denoted by the same symbols.

In operation example 2, the CPU 621 issues a read request to the main memory 100 in the SB 40. The CPU 621 is managed by the recording unit 200 of the system controller 80.

When there is a mishit for this read request in the cache memory 14 of the CPU 621, the CPU 621 issues a read request to the request processing unit 160 in the SC 80 that manages the main memory 100 of the request target. When the read request is a request that eventually caches data and the address as the target of the read request (For example, adr=0) has already been recorded in the recording unit 200, the information corresponding to that address is deleted from the recording unit 200 because a different node (SB 40) has cached the data.

### Operation Example 3

FIG. 15 will be referred to so as to explain operation example 3. FIG. 15 illustrates operation example 3 of the recording unit.

FIG. 15A illustrates a format of an entry of the recording unit 200. An entry includes a mode section 36 and an address section 38. In the mode section 36, information indicating a cache status, i.e., mode=0x or mode=1x, is recorded. 0x indicates “null” and 1x indicates “all I”. Information indicating a cache status in the mode section 36, i.e., a higher address of a request address and the mode corresponding to the status, is written to the address section 38.

FIG. 15B illustrates an example of using the DIR 120 and the recording unit 200, where, when all statuses of the thirty-two entries obtained as a result of reading the DIR 120 with request address [28:11] are “I”, “1x” is written to the mode section 36 of the recording unit 200. When at least one of the statuses of the entries obtained from the DIR 120 is not “I”, no information is written to the recording unit 200.

In the DIR 120, one entry uses an area of 2[bytes] for one cache line as described above. In the DIR 120, one reading operation can read 64 [bytes] of information.

When one reading operation performed on the DIR 120 can read statuses of CPUs (blocks) of a plurality of system boards, the fact that CPUs in a plurality of SBs 40 through 47 are “Invalid” can be recorded in the recording unit 200 when all of the statuses are “Invalid”.

In such a case, a reading operation performed on the DIR 120 can read a block of 2[bytes]×thirty-two entries. The DIR 120 is used for indicating a status for each cache line, and accordingly statuses for areas of 64[bytes]×32=2 [Kbyte] can be recorded in the recording unit 200 at one time.

### Operation Example 4

FIG. 16 will be referred to so as to explain operation example 4. FIG. 16 illustrates a format and a use example as operation example 4 of the recording unit.

In operation example 4, the status “Shared” or a combination of “Invalid” and “Shared” has been added to the recording format of the recording unit 200.

As illustrated in FIG. 16A, statuses of all “S” or statuses including both “I” and “S” (all I or S) have been added to the mode section 36 of the format of the recording unit 200. When all of a plurality of blocks read by one reading operation performed on the DIR 120 are “I”, the address information for reading the DIR 120 is written to the address section 38, and “10” is written to the mode section 36.

When a plurality of blocks that can be read by one reading operation performed on the DIR 120 are “S” or include both “S” and “I”, “11” is written to the mode section 36 and the address information for reading the DIR 120 is written to the address section 38 as illustrated in FIG. 16B.

By adding status bits as described above, it is possible to record statuses in the recording unit 200 not only when a plurality of blocks that can be read by one reading operation from the DIR 120 are all “I” but also when they include all “S” or both “S” and “I”.

### Operation Example 5

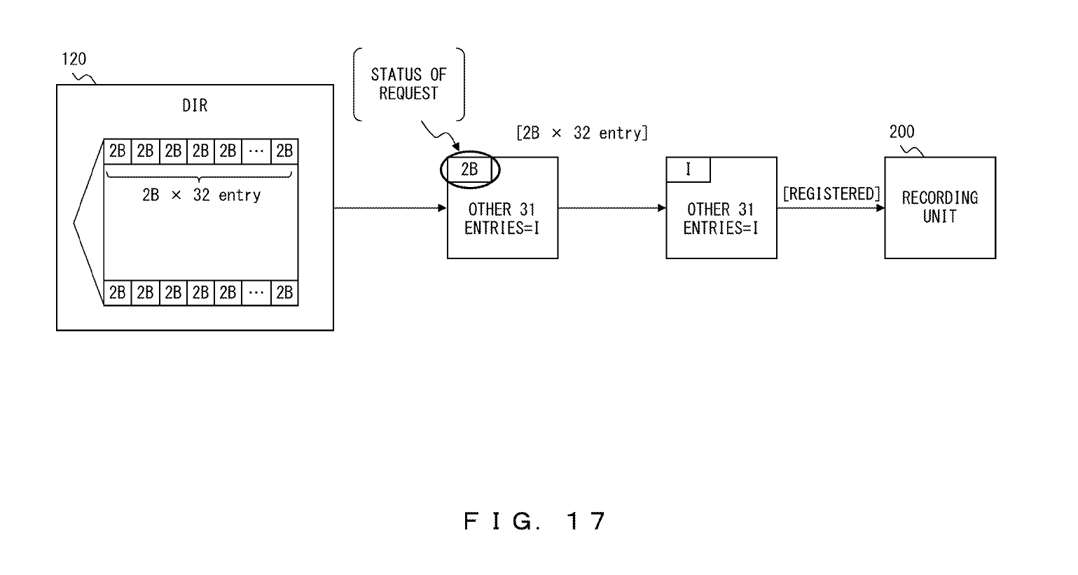

Operation example 5 will be explained by referring to FIG. 17. FIG. 17 illustrates operation example 5.

The DIR 120 is read in response to a request. When all statuses except for the status of the CPU that made a request from among statuses of CPUs that are controlled by the recording unit 200 and were read at the same time are “I” and this request eventually becomes “Invalid”, all of the statuses of the thirty-two entries that were read at the same time are “Invalid”. In such a case, statuses can be recorded in the recording unit 200.

### Operation Example 6

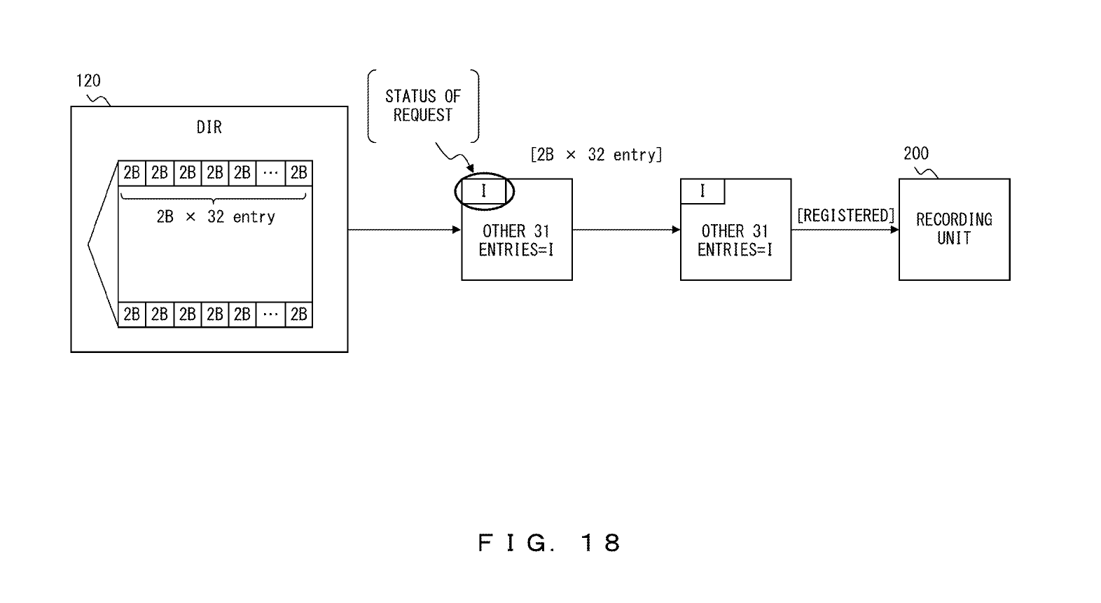

FIG. 18 will be referred to so as to explain operation example 6. FIG. 18 illustrates operation example 6.

When all statuses of CPUs, managed by the recording unit 200, that were read at the same time as a result of reading the DIR 120 in response to a request are “I” and all of the statuses are still “I” after the process of this request, all of the statuses of the thirty-two entries that were read at the same time become “Invalid”. In such a case, statuses can be recorded in the recording unit 200.

### Operation Example 7

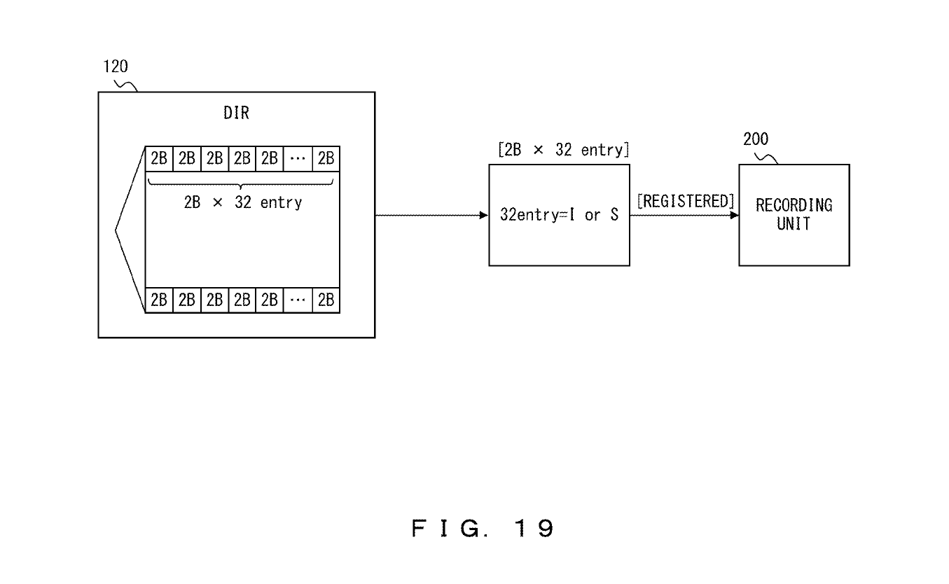

FIG. 19 will be explained so as to explain operation example 7. FIG. 19 illustrates operation example 7.

There is a read request from the CPU 620 not managed by the recording unit 200, and the DIR 120 is read in response to this read request. In such a case, when all the statuses of the entries of the CPUs, managed by the recording unit 200, that were read at the same time are “I” or “S”, all of the statuses of the thirty-two entries read at the same time are “I” or “S”. In such a case, statuses can be recorded in the recording unit 200.

### Operation Example 8

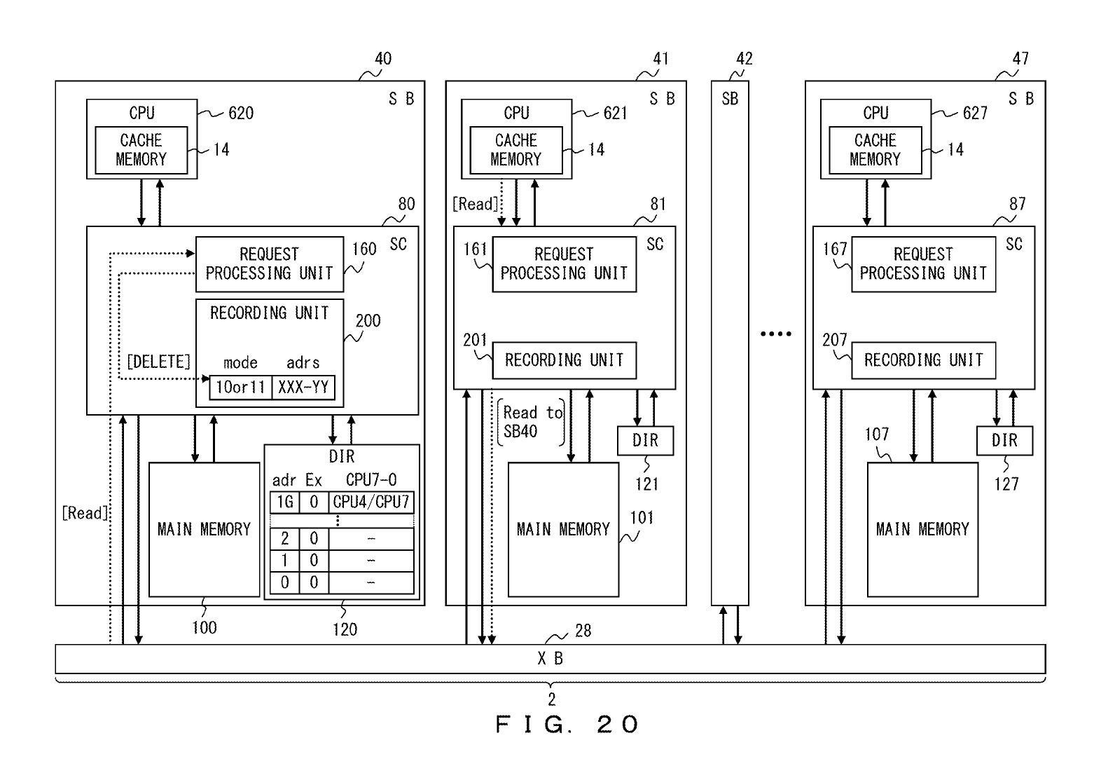

FIG. 20 will be referred to so as to explain operation example 8. FIG. 20 illustrates operation example 8.

A case will be explained where the CPU 621 issues a read request to the main memory 100 in the SB 40. It is assumed that the CPU 621 is managed by the recording unit 200.

When there is a mishit for this read request in the cache memory 14 of the CPU 621, the CPU 621 issues a read request to the request processing unit 160 in the SC 80 that manages the main memory 100 as the request target. When the read request is a request that eventually caches data, the SC 80 determines whether or not the address of the read request is included in cache lines recorded in the recording unit 200. When the address of the request target is included in cache lines recorded in the recording unit 200, it is interpreted that the CPU 620 managed by the recording unit 200 has cached the data. In such a case, the SC 80 deletes information related to the request target data from the recording unit 200.

### Operation Example 9

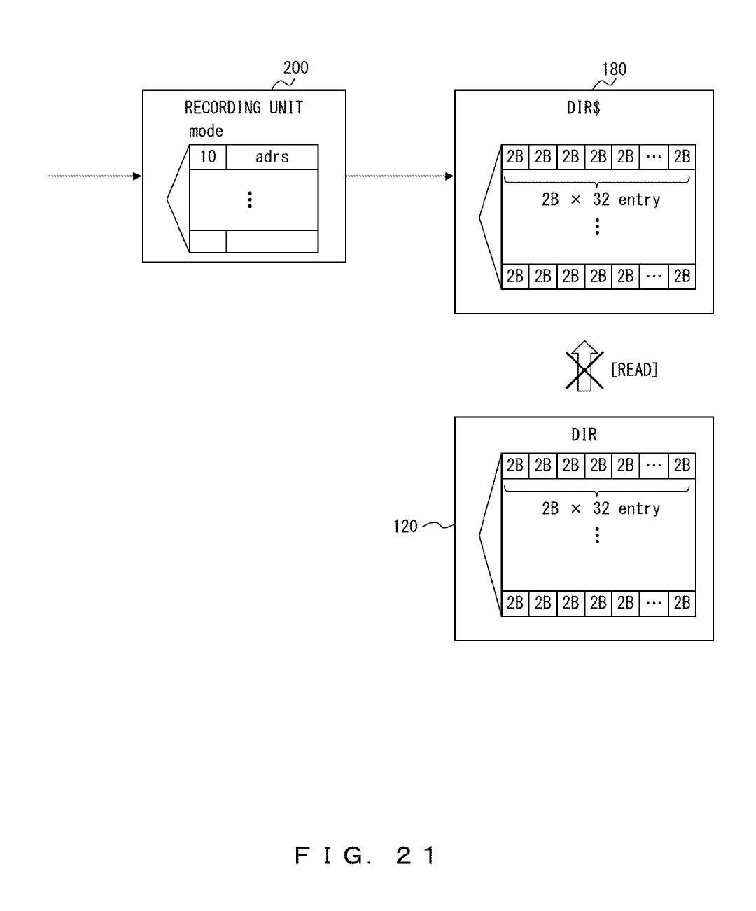

FIG. 21 will be referred to so as to explain operation example 9. FIG. 21 illustrates operation example 9.

There is a case where the CPU 620 managed by the recording unit 200 caches data in response to a read request, and deletes information related to the read request data from the recording unit 200. In such a case, when the status of the cache line to be deleted is “I”, statuses of cache lines recorded in the recording unit 200 are decompressed/developed to the statuses of the thirty-two entries, and each status is recorded in the corresponding entry in the DIR$ 180. Accordingly, in operation example 9, it is not necessary to read statuses from the DIR 120, and latency in reading memory can be reduced because statuses are recorded in the DIR$ 180 from the recording unit 200.

### Operation Example 10

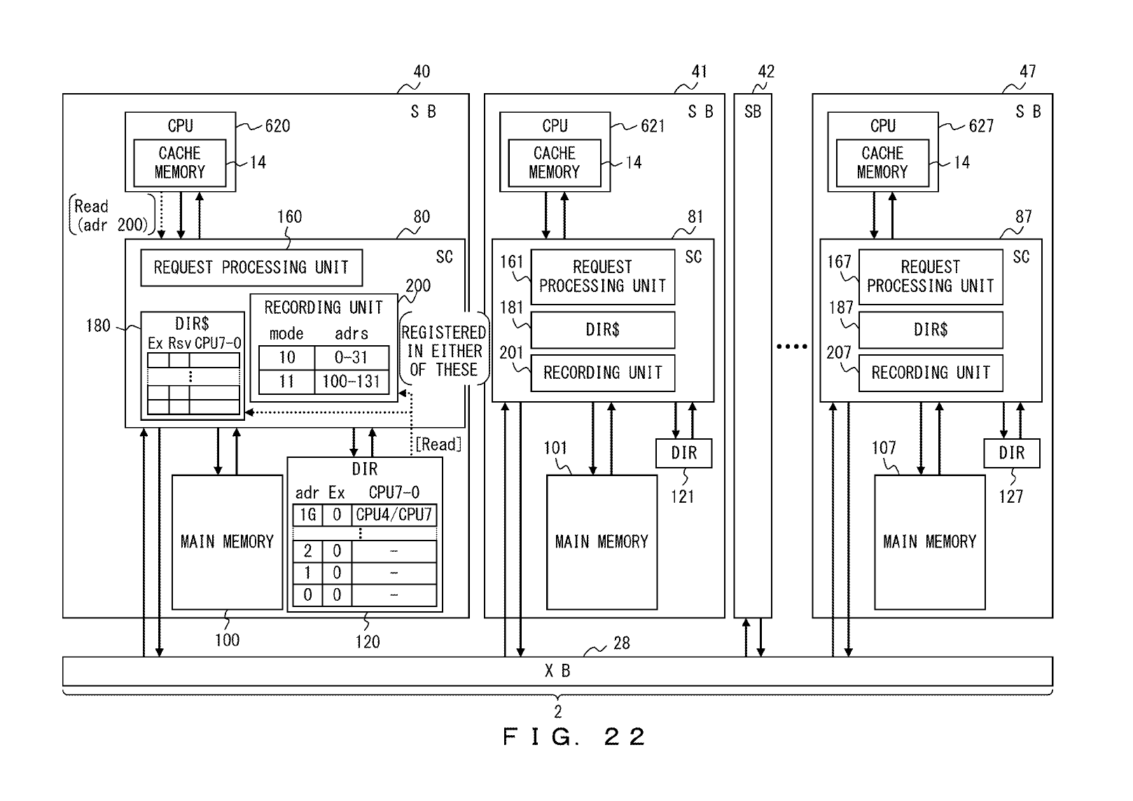

FIG. 22 will be explained so as to explain operation example 10. FIG. 22 illustrates operation example 10.

Operation example 10 is an operation performed when the CPU 620 issues a read request to the main memory 100 in SB 40, which is the subject node including the CPU 620.

When there is a mishit for this read request in the cache memory 14 of the CPU 620, the CPU 620 issues a read request to the request processing unit 160 in the SC 80. The request processing unit 160 searches the DIR$ 180 and the recording unit 200 in the SC 80. When there is a mishit in the DIR$ 180 and the recording unit 200, the SC 80 reads the DIR 120. The SC 80 records, in the DIR$ 180 or the recording unit 200, information obtained by reading the DIR 120.

### Operation Example 11

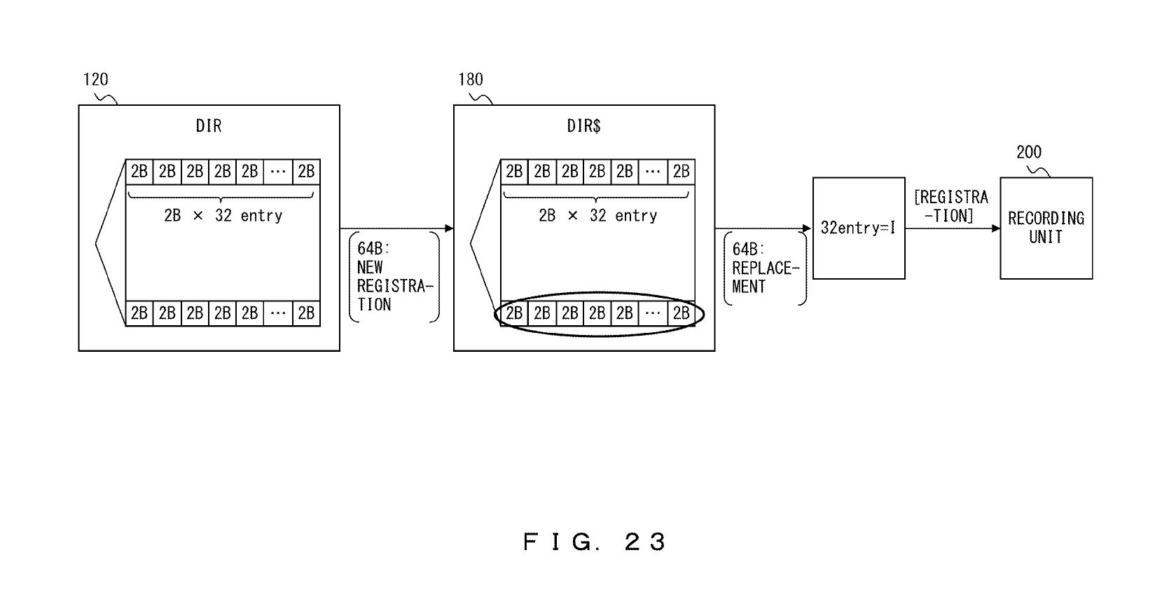

FIG. 23 will be referred to so as to explain operation example 11. FIG. 23 illustrates operation example 11.

In this case, it is assumed that the DIR 120 and the recording unit 200 manage the same CPU.

In a case when the DIR$ 180 does not have a free area when the thirty-two entries read from the DIR 120 are to be recorded to the DIR$ 180, the DIR$ 180 is made to generate a free area. Specifically, as a process of discarding old data in the DIR$ 180, a replacing operation is performed on the DIR$ 180. When all of the statuses of a replaced 64 [bytes] of information are “Invalid”, a fact that statuses of a plurality of blocks are “Invalid” is recorded in the recording unit 200.

### Operation Example 12

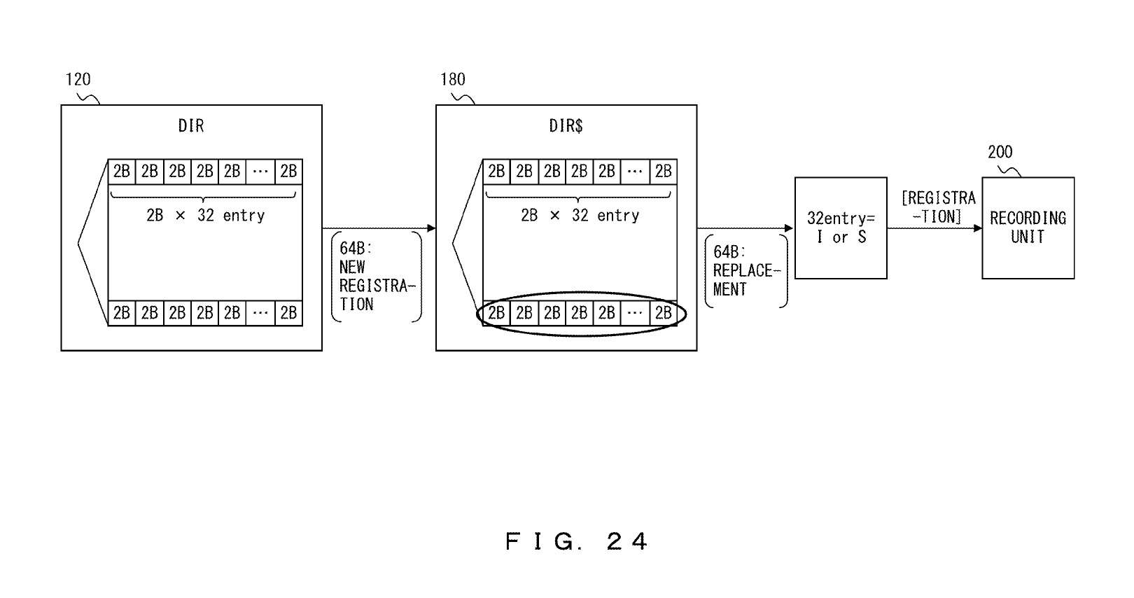

FIG. 24 will be referred to so as to explain operation example 12. FIG. 24 illustrates operation example 12.

In this case too, the DIR 120 and the recording unit 200 manage the same CPU.

In a case when the DIR$ 180 does not have a free area when the thirty-two entries read from the DIR 120 are to be recorded in the DIR$ 180, the DIR$ 180 is made to generate a free area. Specifically, in order to discard old data from the DIR$ 180, a replacing operation is performed on the DIR$ 180. When all of the statuses of a replaced 64 [bytes] of information are “Shared” or they include both “Invalid” and “Shared”, a fact that statuses of a plurality of blocks are “Shared” or include both “Invalid” and “Shared” is recorded in the recording unit 200.

### Operation Example 13

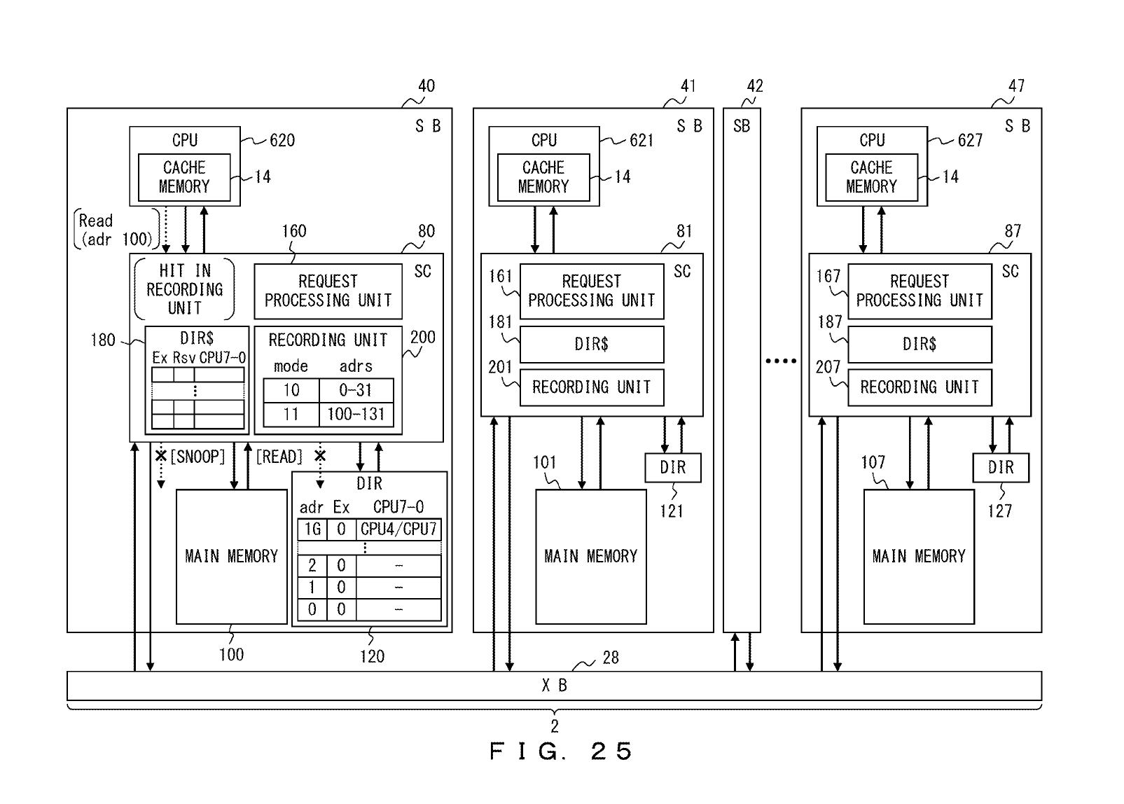

FIG. 25 is referred to so as to explain operation example 13. FIG. 25 illustrates operation example 13.

In this case too, the DIR 120 and the recording unit 200 manage the same CPU.

Operation example 13 is a case when a read request (adr 100) is issued by the CPU 620 to the main memory 100 in the SB 40.

When there is a mishit for this read request in the cache memory 14 of the CPU 620, the CPU 620 issues a read request to the request processing unit 160 in the SC 80. The request processing unit 160 that has received the read request searches the DIR$ 180 and the recording unit 200 in the SC 80. In the example of FIG. 25, the recording unit 200 has stored information at the address of “100”, and has recorded information that the CPU 620 managed by the recording unit 200 has not cached data as the read request. In other words, the mode of the address of “100” recorded in the recording unit 200 is “mode10=all I”. Accordingly, the SC can perform determination about the suppression of reading operations on the CPU managed by the recording unit 200 without reading information from the DIR 120. Accordingly, latency based on read requests can be reduced by the suppression of reading operations on the DIR 120.

### Operation Example 14

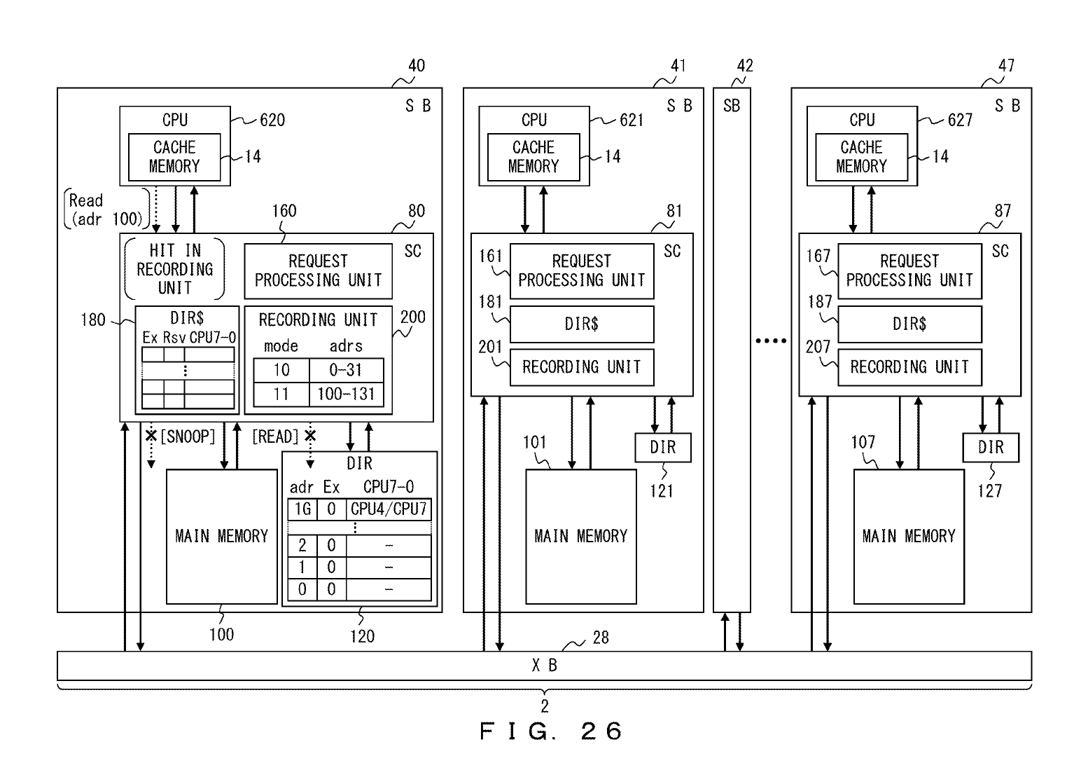

FIG. 26 will be referred to so as to explain operation example 14. FIG. 26 illustrates operation example 14.

In this case too, the DIR 120 and the recording unit 200 manage the same CPU. However, the CPU 620 is not managed by the recording unit 200.

This example is a case when the CPU 620 issues a read request (adr 100) to the main memory 100 in the SB 40.

In this case, it is assumed that the read request is a request that does not include an exclusive right request. When there is a mishit for this read request in the cache memory 14 of the CPU 620, the CPU 620 issues a read request to the request processing unit 160 in the SC 80. The request processing unit 160 that has received the read request searches the DIR$ 180 and the recording unit 200 in the SC 80.

The recording unit 200 has recorded information at the address of “100”, and has recorded information indicating that the CPU managed by the recording unit 200 has cached that data with “I” or “S” (i.e., mode11=all I or S).

In such a case, because the read request is a request not including an exclusive right request, it is not necessary to read the CPU managed by the recording unit 200. That is, the SC can perform determination about the suppression of reading operations on the CPU that its possesses without reading the DIR 120. Accordingly, it is possible to reduce latency caused by read requests by suppressing reading operations on the DIR 120.

The CPU 620 that has issued a request does not have to write the status of the CPU 620 to the DIR 120 even when the CPU 620 is to cache the data eventually because the CPU 620 is not managed by the recording unit 200.

### Operation Example 15

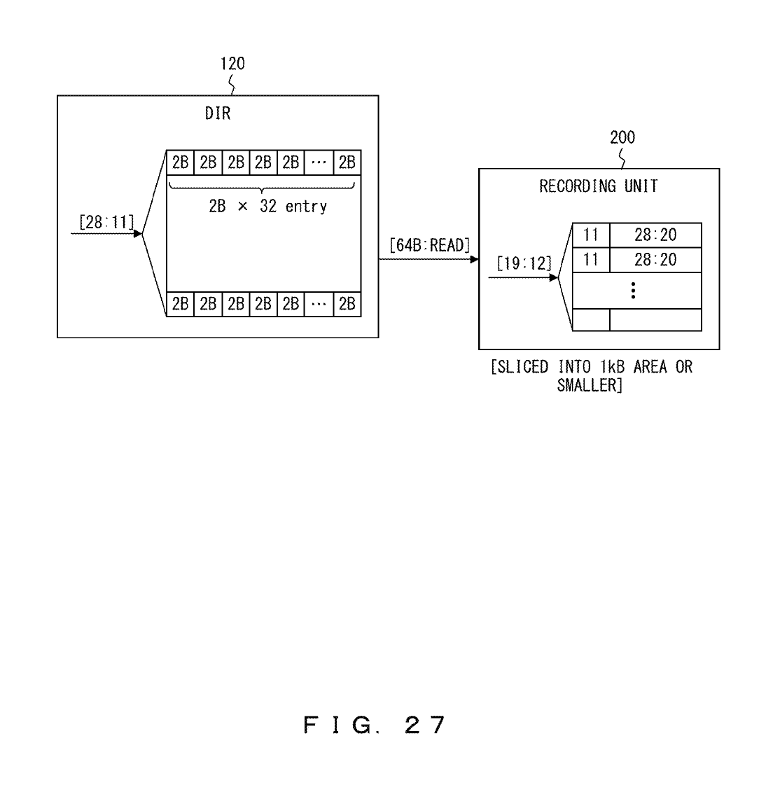

FIG. 27 will be referred to so as to explain operation example 15. FIG. 27 illustrates operation example 15.

A reading operation on the DIR 120 can record information in an area of 2 [Kbytes] in the recording unit 200 at one time. When, for example, the minimum page size of the CPU is equal to or smaller than 2 [Kbytes], such as 1 [Kbytes], information can be recorded in units of 2 [Kbytes] or smaller in the recording unit 200. In other words, information can be recorded in the recording unit 200 after being sliced into a piece of information equal to or smaller than the minimum page size of the CPU.

### Alternative Embodiment

(1) In the second embodiment, explanations have been given for examples of operations of the SB 40 in detail on an assumption that the SB 40 is the subject node. However, different nodes operate in a similar manner.

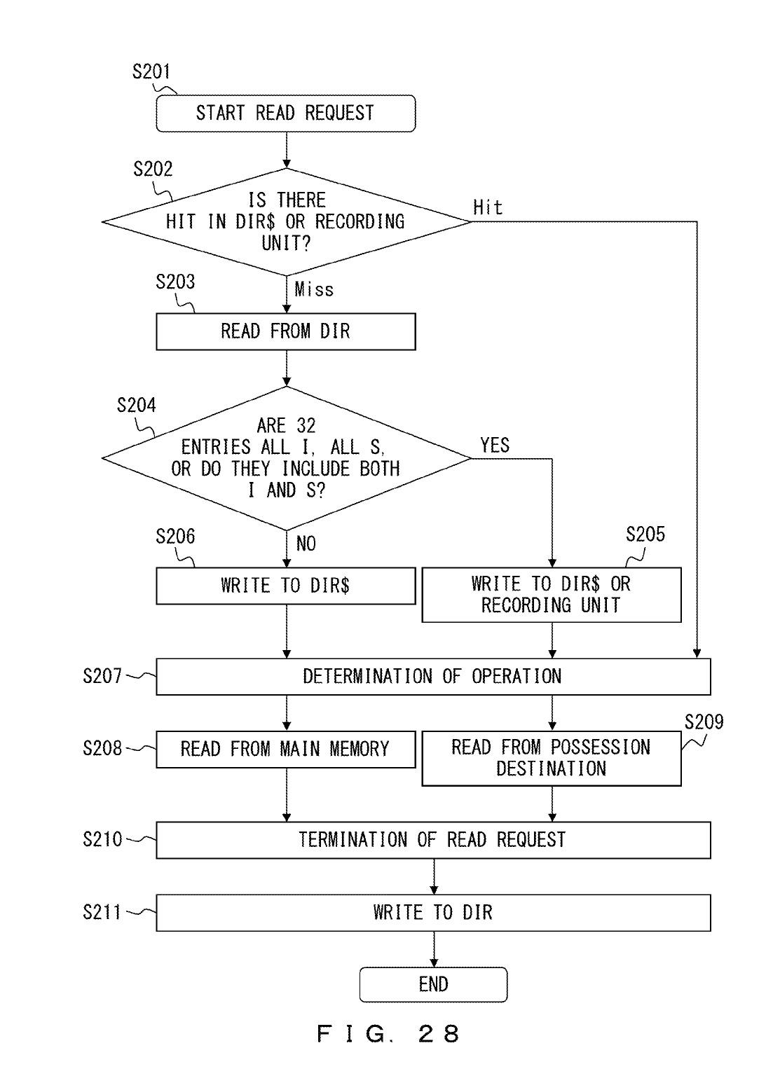

(2) The access process according to the above embodiment is as illustrated in FIG. 10, but is not limited to this. As illustrated in FIG. 28, this access process may include the above described search in the DIR$ 180 and the recording unit 200 and the writing process. In this process sequence, at the start of a read request (step S201), a read request is made to, for example, the address of “2” in the main memory. In such a case, the DIR$ 180 and the recording unit 200 are searched so as to determine whether or not at least one of them has recorded the information at the address of “2” (step S202). When the DIR$ 180 or the recording unit 200 has recorded the information at the address of “2” (Hit in step S202), the process proceeds to the operation determination (step S207).

When the DIR$ 180 or the recording unit 200 have not recorded the information at the address of “2” (Miss in step S202), the SC reads statuses including the status of the address of “2” from the DIR (step S203). In such a case, not only the status of the address of “2” but also other statuses can be read from the DIR. Accordingly, the SC determines whether or not all of the statuses of the thirty-two entries are either “I” or “S” or they include both “I” and “S” (step S204). When all the statuses of the thirty-two entries are “I”, when all of them are “S”, or when they include both “I” and “S” (YES in step S204), the SC performs a writing operation on the DIR$ 180 or the recording unit 200 (step S205). In other words, when all of the read statuses including the address of “2” are “Invalid”, when all of them are “Shared”, or when they include both “Invalid” and “Shared”, the SC can perform a writing operation on the recording unit 200, and in such a case, the status information may be recorded in the DIR$ 180. When the situation is not that all the statuses of the thirty-two entries are “I”, all of them are “S”, or they include both “I” and “S” (NO in step S204), the SC performs a writing operation on the DIR$ 180 (step S206). In other words, when it is not possible to record status information in the recording unit 200, the SC performs a writing operation on the DIR$ 180.

Because the current status of the address of “2” has been recognized by the above process, the SC determines the operation (step S207), and performs a reading operation on the main memory 100 (step S208) or a reading operation on the possession destination (step S209), which has already been described. Thereafter, the process proceeds to request termination (step S210). The status of the address of “2” changes in response to the termination of a request, and accordingly the status of the address of “2” is written to the DIR (step S211), and this process is terminated.

### Alternative Embodiment

(1) In the above embodiment, explanations have been given for cases where all statuses are “Invalid”, all of them are “Shared”, and they include both “Invalid” and “Shared” as examples, but these examples are not used in a limiting sense. The information processing apparatus, the method of controlling a memory, and the memory controlling apparatus according to the present disclosure achieve the intended effects when at least all target statuses are “Invalid” or all of them are “Shared”.

(2) In the second embodiment, it is determined whether or not “thirty-two entries are all I, all S, or they include both I and S” in steps S106 and 116, but this example is not used in a limiting sense. The present invention achieves the intended effects even when all of the thirty-two entries are “Invalid” or when all of them are “Invalid” or “Shared” (i.e., they include both “Invalid” and “Shared” or when all of them are “Shared”).

(3) In step S103 of the above embodiment (FIG. 10), when there is a hit in either the DIR$ 180 or the recording unit 200, the process determines operations (step S104), but this example is not used in a limiting sense. The process may determine operations (step S104) when there is a hit in both the DIR$ 180 and the recording unit 200.

(4) In step S111 of the above embodiment (FIG. 10), when there is a hit in either DIR$ 180 or the recording unit 200, the process proceeds to step S112, but this example is not used in a limiting sense. The process may proceed to step S112 when there is a hit in both the DIR$ 180 and the recording unit 200.

(5) The main memory is read (steps S108 and S122) and the possession destination is read (steps S109 and S123) after the operation determination (step S104 or step S114) in the above embodiment (FIG. 10). However, only one of the processes may be executed.

### Comparison Example 1

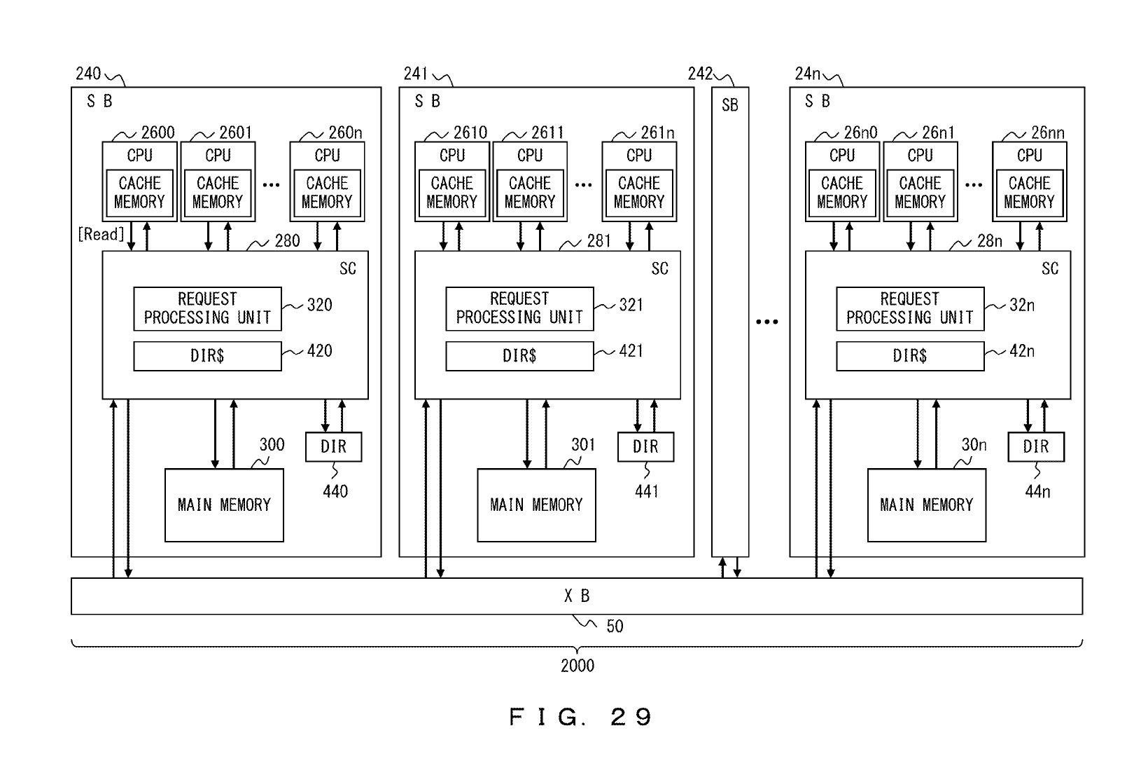

FIG. 29 will be referred to so as to explain comparison example 1. FIG. 29 illustrates comparison example 1. An information processing apparatus 2000 in comparison example constitutes a large-scale system. The information processing apparatus 2000 includes a plurality of SBs 240, 241, . . . , 24n that are connected through a crossbar (XB) 50 as illustrated in FIG. 29.

Also, DIRs 440 through 44n are provided, and a DIR$ 420 as a substitute for a cache TAG 340 and a recording unit 360 are used for the SC 280. This configuration applies to different nodes.

In this configuration, when there is a miss in the DIR$ 420 for a read request, the DIR 440 is read so that the CPU that is holding the data can be searched, and the penalty caused by that miss in the DIR$ 420 is reduced. However, the capacity of the DIR$ 420 is limited, and the volume has to be increased in order to increase the hit ratio. This leads to a higher cost, reducing the practicability.

### Comparison Example 2

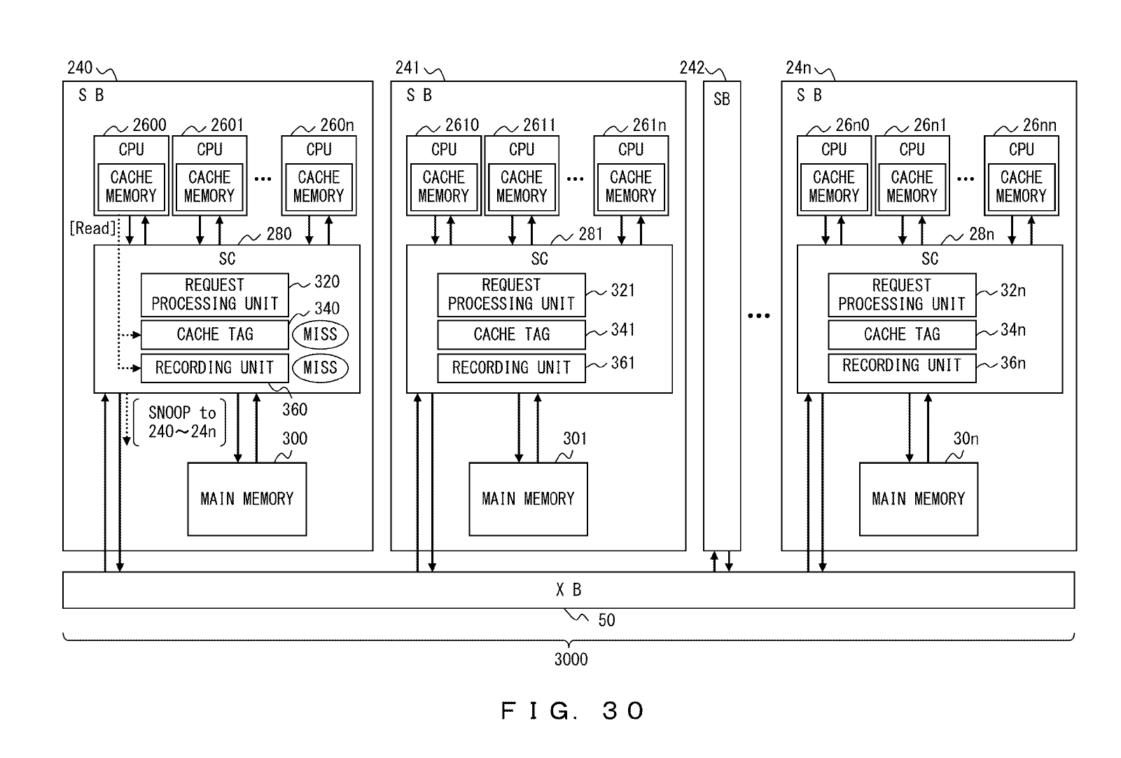

FIG. 30 will be referred to so as to explain comparison example 2. FIG. 30 illustrates comparison example 2. An information processing apparatus 3000 of comparison example 2 constitutes a large-scale system similarly to comparison example 1. The information processing apparatus 3000 includes a plurality of SBs 240 through 24n that are connected through the crossbar (XB) 50, as illustrated in FIG. 30.

In this configuration, a CPU 2600 issues a read request to a main memory 300 in the SB 240. When there is a mishit in the cache memory for this read request, a read request is issued to a request processing unit 320 that manages the main memory 300 of the request target. The request processing unit 320 that has received this request searches the cache TAG 340 and the recording unit 360.

As a result of this search, there are cases where it is not possible for the cache TAG 340 and the recording unit 360 to determine whether or not a CPU that is out of nodes has cached the read target. In such a case, a penalty is imposed to search the cache TAGs 340 through 34n of the SC 280 through 28n, making the latency longer. The larger the system is, the longer this penalty becomes.

In comparison example 1 and comparison example 2, the problem of extended latency in memory reading has been solved by the system described above according to the above embodiment.

As described above, embodiments of the information processing apparatus, the method of controlling a memory, and the memory controlling apparatus according to the present disclosure have been explained. However, the scope of the present disclosure is not limited to the above description. It is needless to say that various modifications or alterations are allowed on the basis of the spirit of the present invention described in the claims or the description and that such modifications or alterations are included in the scope of the present invention.

The information processing apparatus, the method of controlling memory, and the memory controlling apparatus according to the present disclosure contribute to increasing speed in accessing memory.

For example, according to the information processing apparatus, the method of controlling a memory, and the memory controlling apparatus according to an embodiment, achieve at least one of the following effects.

(1) It is possible to reduce latency in reading memory.

(2) An information processing apparatus constituting a large-scale system can reduce average latency in reading memory.

(3) Reduction in average latency in reading memory can increase speed in accessing memory.

Other purposes, features, and advantages according to the embodiments will be made clearer by referring to the drawings and the respective examples.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus provided with a plurality of nodes each including at least one processor, a system controller, and a main memory, the information processing apparatus comprising:
a status storage unit that stores statuses of a plurality of cache lines and that is capable of reading statuses of a plurality of cache lines by one reading operation; and
a recording unit that is provided in a system controller in at least one node and that records all or part of the statuses stored in the status storage unit, wherein
the system controller records obtained statuses in the recording unit on a condition that all of the statuses of the plurality of cache lines obtained by reading the status storage unit are invalid statuses or shared statuses indifferent nodes when the system controller has read the status storage unit in response to a request.

2. The information processing apparatus according to claim 1, wherein
when a request has been made by a different node to the node of the system controller, the request is a type of a request that eventually caches data, and the status of the request is included among records in the recording unit, the system controller deletes the status from the recording unit

3. The information processing apparatus according to claim 1, wherein
when the system controller has read a status in the status storage unit in response to a request and the read status indicates that data as a target of the request has not been cached in a processor, the system controller records in the recording unit information indicating that the data is not possessed by a different node.

4. The information processing apparatus according to claim 1, wherein
when the processor has issued a read request to the main memory and the read request is a request that causes caching of data, the system controller deletes an address specified by the request from the recording unit.

5. The information processing apparatus according to claim 1, wherein
the recording unit records a plurality of cache lines in one status and includes in the status a status indicating that a plurality of nodes are all invalid.

6. The information processing apparatus according to claim 3, wherein
the recording unit includes, in recorded statuses, a status indicating that all statuses of a plurality of cache lines are shared or invalid.

7. The information processing apparatus according to claim 3, wherein
when the system controller has read the status storage unit in response to a request, a status of a read address indicates that processors managed by the recording unit become invalid after a request process and statuses of a plurality of cache lines read at the same time are invalid in all of the processors, the system controller records invalidity in the recording unit.

8. The information processing apparatus according to claim 1, wherein
when the system controller has read the status storage unit in response to a request, all processors managed by the recording unit are invalid in a plurality of nodes that were able to be read at the same time, including a status of the read address in the status storage unit, and a status of the read address does not change after the request process, the system controller records information in the recording unit.

9. The information processing apparatus according to claim 1, wherein
when the system controller has read the status storage unit in response to a read request that does not need an exclusive right to the main memory in the node from a processor not managed by the recording unit and all statuses of a plurality of cache lines read at the same time including the address are invalid or shared in the processors managed by the recording unit, the system controller records information in the recording unit.

10. The information processing apparatus according to claim 1, wherein
when a processor managed by the recording unit has issued a read request to the main memory in the node, the read request is a request that caches data eventually, and the recording unit has recorded information of a plurality of cache lines including the address, the system controller deletes the information from the recording unit.

11. The information processing apparatus according to claim 1, the information processing apparatus comprising:
the status storage unit as a first status storage unit; and
a second status storage unit that caches storage content of the first status storage unit, wherein
when the first status storage unit and the recording unit manage a same processor and the status is invalid, the system controller processes a request after recording in the second status storage unit a fact that all statuses of a plurality of nodes are invalid without reading the first status storage unit.

12. The information processing apparatus according to claim 11, wherein
when a read miss has occurred in the recording unit and the second status storage unit in response to a request and the system controller has read the first status storage unit, the system controller records information in the recording unit or the second status storage unit.

13. The information processing apparatus according to claim 11, wherein
when all statuses of a plurality of nodes discarded by the second status storage unit via replacement are invalid, the system controller records invalidity in the recording unit.

14. The information processing apparatus according to claim 11, wherein
when all statuses of a plurality of nodes discarded by the second status storage unit via replacement are invalid or shared, the system controller records an invalid status or a shared status in the recording unit.

15. The information processing apparatus according to claim 11, wherein
when a processor has issued a read request to a main memory in the node and there is a hit in an invalid status in the recording unit, the information processing apparatus determines that snooping has not been performed on a processor managed by the recording unit without reading the status storage unit.

16. The information processing apparatus according to claim 1, wherein
when a read request that does not need an exclusive right has been issued from a processor not managed by the recording unit to a main memory in the node and there is a hit in an invalid status or a shared status in the recording unit, the information processing apparatus is determined, without reading the status storage unit, that snooping outside of the node has not been performed, and a process is completed with an element that issued a read request being in a shared status.

17. The information processing apparatus according to claim 1, wherein
when a region covered by statuses of a plurality of nodes that are able to be read by one reading operation of the status storage unit is equal to or greater than a minimum page size of a processor, a result of reading the status storage unit is sliced into information equal to or smaller than the minimum page size in the recording unit and as many statuses as the number of sliced results are recorded in and managed by the recording unit.

18. A method of controlling memory of an information processing apparatus provided with a plurality of nodes each including at least one processor, a system controller, and a main memory, the method comprising:
reading, in response to a request, a status storage unit that stores statuses of a plurality of cache lines and that is capable of reading statuses of a plurality of cache lines by one reading operation, and reading statuses of cache lines; and
recording information in a recording unit when statuses of the plurality of cache lines obtained by the reading of the status storage unit are all invalid or shared at least in different nodes.

19. A memory controlling apparatus of an information processing apparatus provided with a plurality of nodes each including at least one processor, a system controller, and a main memory, the memory controlling apparatus comprising:
a system controller that
reads, in response to a request, a status storage unit that stores statuses of a plurality of cache lines and that is capable of reading statuses of a plurality of cache lines by one reading operation, and reads statuses of cache lines; and
records information in a recording unit when statuses of the plurality of cache lines obtained by the reading of the status storage unit are all invalid or shared at least in different nodes.
